(19) United States
(12) Patent Application Publication
(10) Pub. No.: US 2024/0178944 A1
(43) Pub. Date: May 30, 2024

(54) ON DEMAND TRANSMISSION OF DEFERRED SEMI-PERSISTENT SCHEDULING FEEDBACK

(71) Applicant: QUALCOMM INCORPORATED, San Diego, CA (US)

(72) Inventors: Konstantinos Dimou, New York, NY (US); Yan Zhou, San Diego, CA (US); Tao Luo, San Diego, CA (US)

(21) Appl. No.: 18/547,841

(22) PCT Filed: Apr. 5, 2022
(86) PCT No.: PCT/US2022/071556

§ 371 Date: Aug. 24, 2023

(30) Foreign Application Priority Data
Apr. 6, 2021 (GR) 20210100230

(51) Int. Cl. H04L 1/1829; H04L 1/1867

(52) U.S. Cl. CPC H04L 1/1854; H04L 1/1896

(57) ABSTRACT

Methods, systems, and devices for wireless communications are described. A user equipment (UE) may be configured with a first configuration that the UE is to use for semi-persistent scheduling transmissions when availability of one or more uplink symbols in which the feedback is scheduled for transmission to a base station changes (e.g., due to a slot format change). The UE may be configured to defer transmission of the feedback until a subsequent uplink resource. The UE may receive, from the base station, an indication of a second configuration that the UE is to use for the semi-persistent scheduling transmissions when availability of one or more uplink symbols in which the feedback is scheduled for transmission to a base station changes. The UE may not defer transmission based on the second configuration.

### CROSS REFERENCES

The present Application is a 371 national stage filing of International PCT Application No. PCT/US2022/071556 by Dimou et al. entitled “ON DEMAND TRANSMISSION OF DEFERRED SEMI-PERSISTENT SCHEDULING FEEDBACK,” filed Apr. 5, 2022; and claims priority to Greek Patent Application 20210100230 by Dimou et al. entitled “ON DEMAND TRANSMISSION OF DEFERRED SEMI-PERSISTENT SCHEDULING FEEDBACK,” filed Apr. 6, 2021, each of which is assigned to the assignee hereof, and each of which is expressly incorporated by reference in its entirety herein.

### TECHNICAL FIELD

The following relates to wireless communications, including on demand transmission of deferred semi-persistent scheduling feedback.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations (or other network entities) or one or more network access nodes, each simultaneously supporting communication for multiple communication devices, which may be otherwise known as user equipment (UE).

In some wireless communications systems, a UE may be configured to transmit feedback based on monitoring for transmissions according to one or more semi-persistent scheduling (SPS) configurations. But due to various circumstances, the resources that are to be used for transmission of feedback may conflict with other resources.

### SUMMARY

The described techniques relate to improved methods, systems, devices, and apparatuses that support on demand transmission of deferred semi-persistent scheduling feedback. Generally, the described techniques provide for a user equipment (UE) being configured with a first configuration that the UE is to use for semi-persistent scheduling transmissions when availability of one or more uplink symbols in which the feedback is scheduled for transmission to a base station changes (e.g., due to a slot format change). The UE may be configured to defer transmission of the feedback until a subsequent uplink resource. The UE may receive, from the base station, an indication of a second configuration that the UE is to use (temporarily) for the semi-persistent scheduling transmissions when availability of one or more uplink symbols in which the feedback is scheduled for transmission to a base station changes. The UE may not defer transmission based on the second configuration.

A method for wireless communications at a user equipment (UE) is described. The method may include receiving a first control message that indicates a first configuration for management of feedback for semi-persistent scheduling transmissions when availability of one or more uplink symbols in which the feedback is scheduled for transmission to a base station changes, generating a set of feedback bits associated with one or more semi-persistent scheduling transmissions, the set of feedback bits scheduled for transmission to the base station in a first set of uplink symbols, identifying that the availability of the first set of uplink symbols for transmission of the set of feedback bits has changed, and receiving a second control message that temporarily overrides the first configuration so that the UE uses a second configuration for management of the set of feedback bits in accordance with the availability of the first set of uplink symbols having changed.

An apparatus for wireless communications at a UE is described. The apparatus may include a processor, memory coupled with the processor, and instructions stored in the memory. The instructions may be executable by the processor to cause the apparatus to receive a first control message that indicates a first configuration for management of feedback for semi-persistent scheduling transmissions when availability of one or more uplink symbols in which the feedback is scheduled for transmission to a base station changes, generate a set of feedback bits associated with one or more semi-persistent scheduling transmissions, the set of feedback bits scheduled for transmission to the base station in a first set of uplink symbols, identify that the availability of the first set of uplink symbols for transmission of the set of feedback bits has changed, and receive a second control message that temporarily overrides the first configuration so that the UE uses a second configuration for management of the set of feedback bits in accordance with the availability of the first set of uplink symbols having changed.

Another apparatus for wireless communications at a UE is described. The apparatus may include means for receiving a first control message that indicates a first configuration for management of feedback for semi-persistent scheduling transmissions when availability of one or more uplink symbols in which the feedback is scheduled for transmission to a base station changes, means for generating a set of feedback bits associated with one or more semi-persistent scheduling transmissions, the set of feedback bits scheduled for transmission to the base station in a first set of uplink symbols, means for identifying that the availability of the first set of uplink symbols for transmission of the set of feedback bits has changed, and means for receiving a second control message that temporarily overrides the first configuration so that the UE uses a second configuration for management of the set of feedback bits in accordance with the availability of the first set of uplink symbols having changed.

A non-transitory computer-readable medium storing code for wireless communications at a UE is described. The code may include instructions executable by a processor to receive a first control message that indicates a first configuration for management of feedback for semi-persistent scheduling transmissions when availability of one or more uplink symbols in which the feedback is scheduled for transmission to a base station changes, generate a set of feedback bits associated with one or more semi-persistent scheduling transmissions, the set of feedback bits scheduled for transmission to the base station in a first set of uplink symbols, identify that the availability of the first set of uplink symbols for transmission of the set of feedback bits has changed, and receive a second control message that temporarily overrides the first configuration so that the UE uses a second configuration for management of the set of feedback bits in accordance with the availability of the first set of uplink symbols having changed.

In some examples of the method, apparatuses, and non-transitory computer-readable medium described herein, receiving the first control message may include operations, features, means, or instructions for receiving a radio resource control message that indicates the first configuration that the UE may be to use for management of the feedback.

Some examples of the method, apparatuses, and non-transitory computer-readable medium described herein may further include operations, features, means, or instructions for transmitting at least a portion of the set of feedback bits in a second set of uplink symbols in accordance with the second configuration being that the UE may be to defer transmission of the feedback.

Some examples of the method, apparatuses, and non-transitory computer-readable medium described herein may further include operations, features, means, or instructions for refraining from transmitting the set of feedback bits in a second set of uplink symbols based on the second configuration being that the UE may be to refrain from deferring transmission of the feedback.

In some examples of the method, apparatuses, and non-transitory computer-readable medium described herein, receiving the second control message may include operations, features, means, or instructions for receiving a downlink control information message or a medium access control layer control element message that indicates the second configuration.

In some examples of the method, apparatuses, and non-transitory computer-readable medium described herein, receiving the second control message may include operations, features, means, or instructions for receiving a radio resource control message that indicates the second configuration.

In some examples of the method, apparatuses, and non-transitory computer-readable medium described herein, receiving the second control message may include operations, features, means, or instructions for receiving the second control message that specifies a number of transmission time intervals during which the second configuration are to be used for management of the feedback.

In some examples of the method, apparatuses, and non-transitory computer-readable medium described herein, identifying that the availability of the first set of uplink symbols may have changed may include operations, features, means, or instructions for receiving a third control message that includes a slot format change indication that changes the availability of the first set of uplink symbols for transmission of the set of feedback bits, where the second configuration may be applied for determining whether to transmit the set of feedback bits based on the slot format change indication.

A method for wireless communications at a base station is described. The method may include transmitting, to a UE, a first control message that indicates a first configuration for management of feedback for semi-persistent scheduling transmissions when availability of one or more uplink symbols in which the feedback is scheduled for transmission to the base station changes, transmitting, to the UE, one or more semi-persistent scheduling transmissions, where a first set of symbols are to be used by the UE for transmitting a set of feedback bits corresponding to the one or more semi-persistent scheduling transmissions, identifying that the availability of the first set of uplink symbols for transmission of the set of feedback bits has change, and transmitting, to the UE, a second control message that temporarily overrides the first configuration so that the UE uses a second configuration for management of the set of feedback bits in accordance with the availability of the first set of uplink symbols having changed.

An apparatus for wireless communications at a base station is described. The apparatus may include a processor, memory coupled with the processor, and instructions stored in the memory. The instructions may be executable by the processor to cause the apparatus to transmit, to a UE, a first control message that indicates a first configuration for management of feedback for semi-persistent scheduling transmissions when availability of one or more uplink symbols in which the feedback is scheduled for transmission to the base station changes, transmit, to the UE, one or more semi-persistent scheduling transmissions, where a first set of symbols are to be used by the UE for transmitting a set of feedback bits corresponding to the one or more semi-persistent scheduling transmissions, identify that the availability of the first set of uplink symbols for transmission of the set of feedback bits has change, and transmit, to the UE, a second control message that temporarily overrides the first configuration so that the UE uses a second configuration for management of the set of feedback bits in accordance with the availability of the first set of uplink symbols having changed.

Another apparatus for wireless communications at a base station is described. The apparatus may include means for transmitting, to a UE, a first control message that indicates a first configuration for management of feedback for semi-persistent scheduling transmissions when availability of one or more uplink symbols in which the feedback is scheduled for transmission to the base station changes, means for transmitting, to the UE, one or more semi-persistent scheduling transmissions, where a first set of symbols are to be used by the UE for transmitting a set of feedback bits corresponding to the one or more semi-persistent scheduling transmissions, means for identifying that the availability of the first set of uplink symbols for transmission of the set of feedback bits has change, and means for transmitting, to the UE, a second control message that temporarily overrides the first configuration so that the UE uses a second configuration for management of the set of feedback bits in accordance with the availability of the first set of uplink symbols having changed.

A non-transitory computer-readable medium storing code for wireless communications at a base station is described. The code may include instructions executable by a processor to transmit, to a UE, a first control message that indicates a first configuration for management of feedback for semi-persistent scheduling transmissions when availability of one or more uplink symbols in which the feedback is scheduled for transmission to the base station changes, transmit, to the UE, one or more semi-persistent scheduling transmissions, where a first set of symbols are to be used by the UE for transmitting a set of feedback bits corresponding to the one or more semi-persistent scheduling transmissions, identify that the availability of the first set of uplink symbols for transmission of the set of feedback bits has change, and transmit, to the UE, a second control message that temporarily overrides the first configuration so that the UE uses a second configuration for management of the set of feedback bits in accordance with the availability of the first set of uplink symbols having changed.

In some examples of the method, apparatuses, and non-transitory computer-readable medium described herein, transmitting the first control message may include operations, features, means, or instructions for transmitting a radio resource control message that indicates the first configuration that the UE may be to use for management of the feedback.

In some examples of the method, apparatuses, and non-transitory computer-readable medium described herein, communicating with the UE may include operations, features, means, or instructions for receiving at least a portion of the set of feedback bits in a second set of uplink symbols in accordance with the second configuration being that the UE may be to defer transmission of the feedback.

Some examples of the method, apparatuses, and non-transitory computer-readable medium described herein may further include operations, features, means, or instructions for determining that the set of feedback bits may be not to be received in a second set of uplink symbols based on the second configuration being that the UE may be to refrain from deferring transmission of the feedback.

In some examples of the method, apparatuses, and non-transitory computer-readable medium described herein, transmitting the second control message may include operations, features, means, or instructions for transmitting a downlink control information message or a medium access control layer control element message that indicates the second configuration.

In some examples of the method, apparatuses, and non-transitory computer-readable medium described herein, transmitting the second control message may include operations, features, means, or instructions for transmitting a radio resource control message that indicates the second configuration.

In some examples of the method, apparatuses, and non-transitory computer-readable medium described herein, transmitting the second control message may include operations, features, means, or instructions for transmitting the second control message that specifies a number of transmission time intervals during which the second configuration are to be used for management of the feedback.

In some examples of the method, apparatuses, and non-transitory computer-readable medium described herein, identifying that the availability of the first set of uplink symbols may have changed may include operations, features, means, or instructions for transmitting a third control message that includes a slot format change indication that changes the availability of the first set of uplink symbols for transmission of the set of feedback bits, where the second configuration may be applied for determining whether to transmit the set of feedback bits based on the slot format change indication.

Some examples of the method, apparatuses, and non-transitory computer-readable medium described herein may further include operations, features, means, or instructions for determining a number of received negative acknowledgments in a number of semi-persistent scheduling occasions or in a number of slots prior to transmission of the second control message, where the second control message may be transmitted based on the number of received negative acknowledgments satisfying a negative acknowledgment threshold.

Some examples of the method, apparatuses, and non-transitory computer-readable medium described herein may further include operations, features, means, or instructions for determining a probability that the UE may be to transmit a negative acknowledgment corresponding to the one or more semi-persistent scheduling transmissions, where the second control message may be transmitted based on the determined probability satisfying a negative acknowledgments probability threshold.

Some examples of the method, apparatuses, and non-transitory computer-readable medium described herein may further include operations, features, means, or instructions for determining that a second set of uplink symbols are to be used for communication of information other than the set of feedback bits, where the second control message may be transmitted based on determining that the second set of uplink symbols are to be used for communication of the information other than the set of feedback bits.

Some examples of the method, apparatuses, and non-transitory computer-readable medium described herein may further include operations, features, means, or instructions for determining a number of received acknowledgments in a number of semi-persistent scheduling occasions or in a number of slots prior to transmission of the second control message, where the second control message may be transmitted based on the number of received acknowledgments satisfying an acknowledgment threshold.

Some examples of the method, apparatuses, and non-transitory computer-readable medium described herein may further include operations, features, means, or instructions for determining a probability that the UE may be to transmit an acknowledgment corresponding to the one or more semi-persistent scheduling transmissions, where the second control message may be transmitted based on the determined probability satisfying an acknowledgment probability threshold.

Some examples of the method, apparatuses, and non-transitory computer-readable medium described herein may further include operations, features, means, or instructions for determining that a second set of uplink symbols are to be unused for communication of information other than the set of feedback bits, where the second control message may be transmitted based on determining that the second set of uplink symbols are to be unused for communication of the information other than the set of feedback bits.

### BRIEF DESCRIPTION OF THE DRAWINGS

FIG. 1 illustrates an example of a wireless communications system that supports on demand transmission of deferred semi-persistent scheduling feedback in accordance with aspects of the present disclosure.

FIG. 2 illustrates an example of a wireless communications system that supports on demand transmission of deferred semi-persistent scheduling feedback in accordance with aspects of the present disclosure.

FIG. 3 illustrates an example of a resource diagram that supports on demand transmission of deferred semi-persistent scheduling feedback in accordance with aspects of the present disclosure.

FIG. 4 illustrates an example of a process flow diagram that supports on demand transmission of deferred semi-persistent scheduling feedback in accordance with aspects of the present disclosure.

FIGS. 5 and 6 show block diagrams of devices that support on demand transmission of deferred semi-persistent scheduling feedback in accordance with aspects of the present disclosure.

FIG. 7 shows a block diagram of a communications manager that supports on demand transmission of deferred semi-persistent scheduling feedback in accordance with aspects of the present disclosure.

FIG. 8 shows a diagram of a system including a device that supports on demand transmission of deferred semi-persistent scheduling feedback in accordance with aspects of the present disclosure.

FIGS. 9 and 10 show block diagrams of devices that support on demand transmission of deferred semi-persistent scheduling feedback in accordance with aspects of the present disclosure.

FIG. 11 shows a block diagram of a communications manager that supports on demand transmission of deferred semi-persistent scheduling feedback in accordance with aspects of the present disclosure.

FIG. 12 shows a diagram of a system including a device that supports on demand transmission of deferred semi-persistent scheduling feedback in accordance with aspects of the present disclosure.

FIGS. 13 through 16 show flowcharts illustrating methods that support on demand transmission of deferred semi-persistent scheduling feedback in accordance with aspects of the present disclosure.

### DETAILED DESCRIPTION

In some wireless communications systems, a user equipment (UE) may be configured to monitor for semi-persistent scheduling (SPS) transmissions (e.g., from a base station). The UE may transmit feedback bits (e.g., hybrid automatic repeat request (HARQ) acknowledgment (ACK) or negative acknowledgement (NACK)) associated with the SPS transmissions using physical uplink control channel (PUCCH) resources configured according to an SPS configuration. In some cases, the resources that are to be used for transmission of the feedback bits may conflict (e.g., collide) with downlink symbols (e.g., radio resource control (RRC) configured downlink symbols). In such cases, the UE may defer the PUCCH (e.g., including the feedback bits) to the next slot that includes one or more uplink symbols that may accommodate the PUCCH transmission. However, in some cases, the base station 105 may determine that the feedback is relatively likely to be an ACK, that the subsequent slots may include few uplink symbols, and/or that an uplink load may not be served within those available uplink symbols.

Techniques described herein support on-demand deferral activation or on-demand deferral deactivation for management of feedback for SPS transmissions when availability of one or more uplink symbols in which the feedback is scheduled for transmission to a base station changes. For example, a UE may be configured with a default first configuration (e.g., RRC configured) for management of feedback when the resources scheduled for the feedback changes. In some cases, the default configuration is that the UE is to defer transmission of the feedback until a subsequent available uplink resource. However, in some cases, the base station may determine that the UE is not to transmit the feedback due to the high likelihood of an ACK or due to the subsequent uplink symbols being used for other uplink information. In such cases, the base station may indicate to the UE (e.g., using control signaling, such as downlink control information (DCI)) that the UE is to temporarily use a second configuration for management of the feedback. The second configuration may be that the UE is to not defer (e.g., not transmit) the feedback when the originally scheduled resources are unavailable (e.g., due to a change in slot format). Thus, using these techniques resources may be efficiently managed, thereby increasing throughput and reliability in a wireless communications system.

In some examples, the first or default configuration is that the UE is to not defer (e.g., not transmit) the feedback when the originally scheduled resources are unavailable. In such cases, the base station may indicate that the UE is to defer transmission of the feedback based on a high NACK probability and/or the lack of use of the subsequent uplink resources for other information. These and other implementations are further described with respect to the figures.

Aspects of the disclosure are initially described in the context of wireless communications systems. Aspects of the disclosure are further described with respect to a wireless communications system using resource formats that may result in feedback resource availability changing, a resource diagram, and a process flow diagram. Aspects of the disclosure are further illustrated by and described with reference to apparatus diagrams, system diagrams, and flowcharts that relate to on demand transmission of deferred semi-persistent scheduling feedback.

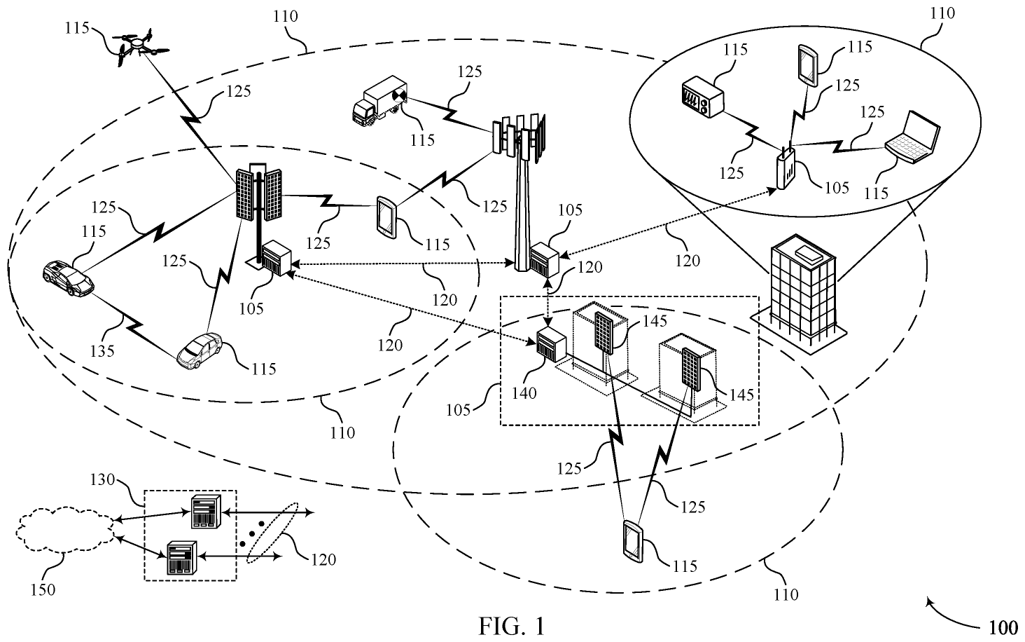

FIG. 1 illustrates an example of a wireless communications system 100 that supports on demand transmission of deferred semi-persistent scheduling feedback in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

A base station 105 may schedule a UE 115 to receive one or more SPS transmissions, which may correspond to physical downlink shared channel (PDSCH) transmissions. The SPS configuration indicated by the base station 105 may include an indication of resources that the UE 115 is to use for transmitting feedback corresponding to the data of the PDSCH/SPS transmissions. For example, the SPS configuration, which may be indicated in a PDCCH, may include an indication of a time gap (e.g., K₁ symbols) between the resources of the PDSCH and the resources of the PUCCH that the UE 115 is to use for transmitting feedback. In some examples, the gap value or K₁ may be indicated via RRC signaling. Further, the base station 105 may change a slot format that the UE 115 and the base station 105 are to use for communications. The slot format change may reduce the amount of uplink symbols available to use by the UE 115 for uplink transmissions. For example, a slot format change indication may change one or more flexible or uplink symbols to downlink symbols. The base station 105 may change the slot format based on various conditions, such as increased downlink communication traffic. In some cases, the change in the slot format may result in PUCCH resources (based on the K₁ value) aligning with a resource that is no longer available for uplink transmission (e.g., the resources are changed to downlink). In such cases, the UE may be configured to defer transmission of the feedback until a subsequent uplink resource.

Techniques described herein support on-demand activation or deactivation of feedback transmission deferral. For example, the base station 105 may determine that the UE 115 is unlikely to transmit a NACK due to various communication traffic patterns, and as such, may determine that the UE 115 is to not defer (e.g., not transmit) the feedback when the original feedback resources are rendered unavailable by a slot format change. Further, the base station may determine that the UE 115 is likely to transmit a NACK or that the uplink resources are not to be used for other uplink information, and may transmit an indication that the UE is to defer transmission of the feedback until an available uplink resource. Accordingly, these techniques may support efficient use of communication resources, thereby increasing communication reliability and throughput.

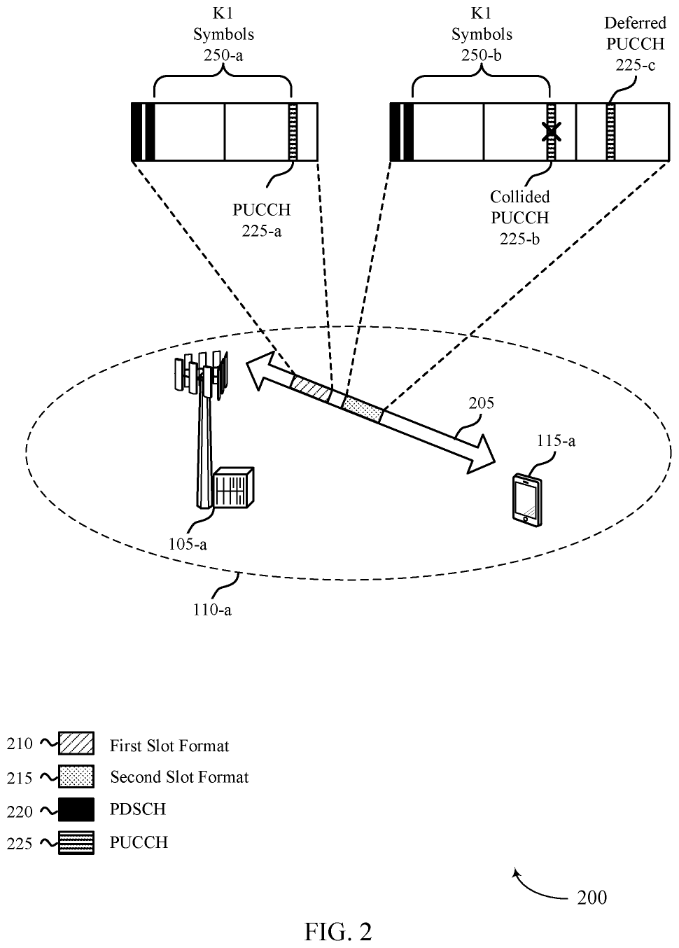

FIG. 2 illustrates an example of a wireless communications system 200 that supports on demand transmission of deferred semi-persistent scheduling feedback in accordance with aspects of the present disclosure. The wireless communications system 200 may implement aspects of wireless communications system 100. For example, the wireless communications system 200 includes a UE 115-a and a base station 105, which may be examples of the corresponding devices of FIG. 1.

In some examples, the base station 105-a and the UE 115-a may communicate via communications link 205 within a coverage area 110-a of the base station 105-a. The UE 115-a may be configured (e.g., using control messaging, such as RRC) to monitor for SPS transmissions (e.g., from a base station 105-a). The UE 115-a may be configured with semi-persistent resources for receipt of a PDSCH 220 and transmission of uplink communications via PUCCH 225, and may monitor for one or more SPS transmissions based on a number of SPS configurations. The resources of the PUCCH 225 may be configured according to an offset or K₁ value 250, which may indicate that the PUCCH 225 resources start a number of symbols after the PDSCH 220 resource. In some cases, the UE 115-a may generate feedback (also referred to herein as ACK/NACK bits) and transmit the feedback in the PUCCH 225 resources.

In a first slot format 210, the PUCCH resources 225-a may align with uplink symbols of the slot, and thus, the UE 115-a may transmit the feedback corresponding to the PDSCH 220 in the PUCCH 315-a resources. In some cases, however, the base station 105-a may transmit an indication to change the slot format to a second slot format 215. For example, the base station 105-a may change the slot format due to increased downlink communications. In various examples, the first slot format 210 may be referred to a slot format 42 with three downlink symbols, three flexible symbols, and eight uplink symbols, and the second slot format 215 may be an example of slot format 33 with nine downlink symbols, three flexible symbols, and two uplink symbols. The slot format change may indicate that flexible symbols are to be used for downlink communications. In some circumstances, the slot format may change without changing the K₁ value that is used to identify the PUCCH 225 resources. As illustrated in the second slot format 215, this scenario may result in some of the PUCCH 225-b resources aligning with downlink symbols of the slot. In such cases, the UE 115-a may be configured (e.g., using an RRC configuration) to defer transmission of the feedback corresponding to the PDSCH 220 until subsequent uplink symbols. For example, the feedback may be transmitted in deferred PUCCH 225-c upon identifying that the PUCCH 225-b resources collide with the downlink symbols of the second slot format 215. This deferral configuration may be a default/RRC indicated configuration.

However, in some cases, the base station 105-a may identify that the UE 115-a is likely to transmit an ACK corresponding to the PDSCH of the SPS transmission. Additionally or alternatively, the base station 105-a may identify that the slot format 215 includes few available uplink symbols or that an uplink load may not be served within the available uplink symbols. In such cases, the base station 105-a may determine that the UE 115-a is to not defer transmission of the feedback when the feedback resources (e.g., PUCCH 225 resources) align with downlink symbols of the slot. That is, the base station 105-a may determine that the UE 115-a is not to transmit the feedback upon this scenario occurring. Techniques described herein support the base station 105-a indicating to the UE 115-a that the UE 115-a is to not defer the feedback. For example, the base station 105-a may transmit a control message (e.g., DCI, MAC-CE, or RRC) message with a second configuration that the UE 115-a is to use for a duration, and the second configuration may be that the UE 115-a is to not defer (e.g., not transmit) the feedback when the original feedback resources align with downlink symbols.

In some examples, the initial, default, or first configuration is that the UE 115 is to not transmit the feedback when the described scenario occurs (e.g., that the original feedback resources align with downlink symbols due to a slot format change). In such cases, the base station 105-a may determine that the feedback is to be transmitted to the base station 105-a. As such, the base station 105-a may transmit a control message indicating a second configuration that the UE 115-a is to use for a duration (e.g., a number of TTIs or slots), where the second configuration specifies that the UE 115-a is to defer transmission of the feedback corresponding to the PDSCH 220 until one or more available uplink symbols. The base station 105-a may determine that the feedback is to be transmitted due to a high likelihood of NACK (low likelihood of ACK), a relatively high number of available uplink symbols, and/or due to the uplink load being servable by the available uplink symbols.

These described on-demand feedback deferral techniques provide flexibility in resource utilization. Thus, the base station 105-a may configure the UE 115-a to use the resources based on various network conditions, which may support improved communication reliability and throughput, among other benefits.

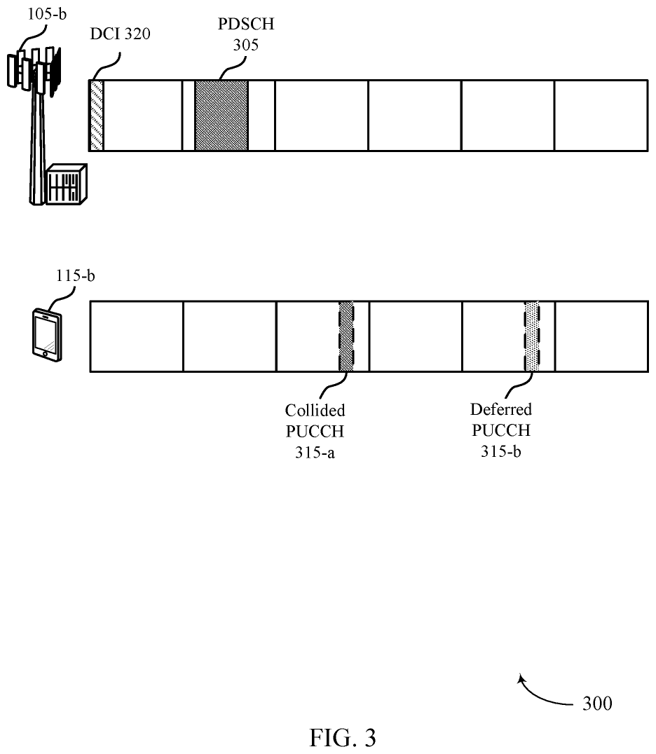

FIG. 3 illustrates an example of a resource diagram 300 that supports on demand transmission of deferred semi-persistent scheduling feedback in accordance with aspects of the present disclosure. In some examples, the resource diagram 300 may be implemented by aspects of the wireless communications systems 100 and 200. For example, the resource diagram 300 includes a base station 105-b and a UE 115-b, which may be examples of corresponding devices described herein with reference to FIGS. 1 and 2.

In some examples, the base station 105-b and the UE 115-b may communicate via a communication link (e.g., communication link 205 as described with reference to FIG. 2). As described herein, the base station 105-b may utilize SPS resources for communicating with the UE 115-b. For example, the SPS configuration may allocate resources for a PDSCH 305-a (transmitted by base station 105-b) and a corresponding PUCCH 315 (transmitted by the UE 115-b). In some cases, the PUCCH 315 resources may be identified relative to the PDSCH 305 (e.g., based on a K₁ value as described with respect to FIG. 2). For example, the PUCCH 315 may be identified relative to the PDSCH 305. The PUCCH 315 may be used to transmit feedback (e.g., HARQ feedback bits) corresponding to the PDSCH 305.

As described herein, the base station 105-b may change a slot format due to various circumstances, such as an increased utilization of downlink resources. In such cases, the PUCCH 315, which may have originally aligned with uplink symbols of the slot format, may align or collide with downlink symbols of the changed slot format. As such, the PUCCH 315-a resources may be unavailable (e.g., the availability has changed) for transmission of the feedback corresponding to the PDSCH 305. The UE 115-b may be configured (e.g., RRC configured) with a first configuration for managing such circumstances.

In one implementation, the first configuration may specify that the UE 115-b is to defer transmission of the feedback (e.g., the feedback bits corresponding to the PDSCH 305) until subsequent available uplink symbols of a slot. As illustrated in FIG. 3, the UE 115-b may transmit the feedback bits using the deferred PUCCH 315-b resources, which may correspond to uplink resources of the updated slot format. Thus, according to the first configuration, the UE 115-b may still transmit the feedback bits when the original resources for the feedback are unavailable.

In some cases, the base station 105-b may determine that the feedback for the SPS PDSCH (e.g., PDSCH 305) is not to be transmitted when the availability of the feedback resources has changed. For example, the base station 105-b may determine that the UE 115-b is unlikely to transmit a NACK or that the subsequent uplink resources are to be used for transmission of other information. In such cases, the base station 105-b may transmit control message, such as a DCI 320, that indicates that the UE 115-b is to use a second configuration for management of feedback when the availability of feedback resources changes. The second configuration may specify that the UE 115-b is not to defer transmission of the feedback. That is, the second configuration may specify that the UE 115-b is to not transmit feedback when the originally scheduled feedback resources collide with a downlink resource of the slot. As discussed herein, if the UE 115-b is unlikely to transmit a NACK (e.g., based on a NACK probability relative to a NACK probability threshold or based on a number of prior NACKs relative to a threshold), then the UE 115-b not transmitting the feedback may not have a significant impact on communications. The base station 105-b may indicate (e.g., via the DCI 320 or via other control messaging) that the UE 115-b is to use the second configuration for a duration, such as a number of TTIs, slots, or SPS occasions. As such, the subsequent uplink resources may be used for other information, thus supporting efficient utilization of resources.

In some cases, the first configuration may be that the UE 115-b is to not defer (e.g., not transmit) the feedback when the original feedback resources collide with a downlink resource due to a slot format change. Thus, according to the first configuration, the UE 115-b may not transmit the feedback when this situation occurs. However, the base station 105-b may transmit the DCI 320 (or other control messaging) that indicates that the UE 115-b is to use a second configuration for a duration (e.g., a number of TTIs or slots). The second configuration may specify that the UE 115-b is to defer transmission of the feedback until a subsequent available uplink resource. Thus, according to the second configuration, the UE 115-b may defer transmission of the feedback until the deferred PUCCH 315-b resources. The base station 105-b may determine that the UE 115-b is to use this second configuration based on a relatively high probability of a NACK (or low probability of an ACK) and/or because the uplink resources are not to be used for other information.

Thus, using these techniques, the UE 115-b may be configured (e.g., using RRC signaling) with a default or first configuration to use when the feedback resources collide with downlink resources. A second configuration may be activated by the base station 105-b such that the UE 115-b uses the second configuration for a duration. As such, the second configuration may override the first configuration for the duration, after which the UE 115-b may use the first configuration (e.g., until the second configuration is reactivated). This activation/deactivation technique may provide greater flexibility in resource management, thus increasing resource utilization efficiencies.

In some cases, both configurations may be RRC configured, and the use of one or the other may be based on a flag, such as a flag in the DCI 320. In some examples, both configurations are configured, and one of the configurations is identified as the default configuration. The on-demand second configuration may be activated in a flag and may be used for some pre-determined or signaled period (e.g., a number of TTIs or slots).

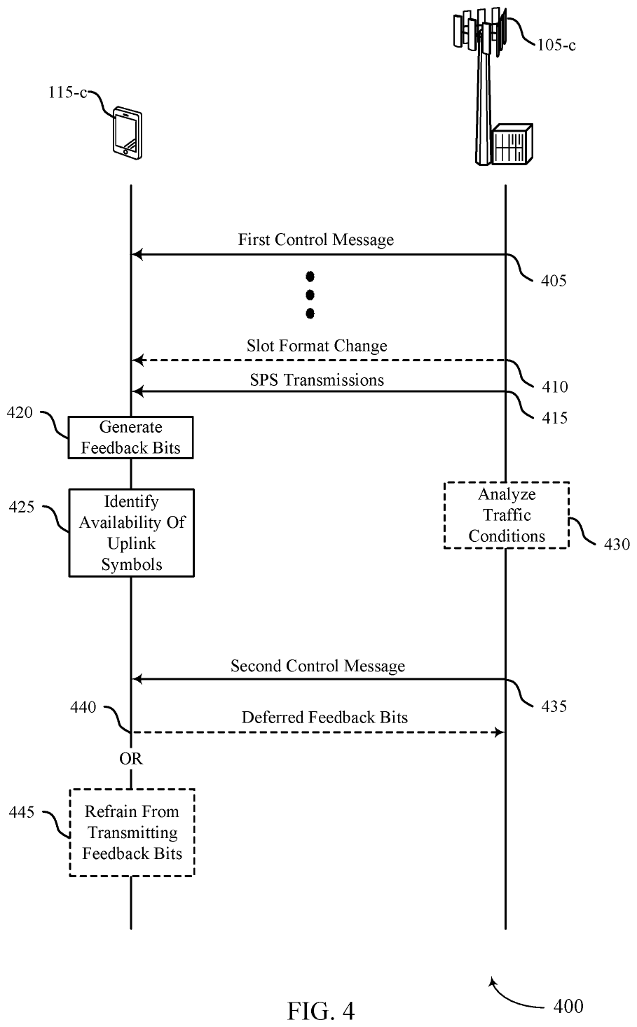

FIG. 4 illustrates an example of a process flow diagram 400 that supports on demand transmission of deferred semi-persistent scheduling feedback in accordance with aspects of the present disclosure. The process flow diagram 400 may implement aspects of wireless communications system 100 and 200 and resource diagram 300 of FIGS. 1 through 3. For example, the process flow diagram 400 includes a base station 105-c and a UE 115-c, which may be examples of aspects of the corresponding devices described with respect to FIGS. 1 through 3.

At 405, the UE 115-c may receive from the base station 105-c, a first control message that indicates a first configuration for management of feedback for semi-persistent scheduling transmissions when availability of one or more uplink symbols in which the feedback is scheduled for transmission to a base station changes. The first control message may be an RRC message. The first configuration may be an example of a default configuration that the UE 115-c is to use. The first configuration may be that the UE is to defer transmission of the feedback until the first available uplink symbols or that the UE is to not defer (e.g., not transmit) the feedback in case the availability of the uplink symbols for the feedback changes.

At 410, UE 115-c may receive, from the base station 105-c, a slot format change indication that changes the availability of the first set of uplink symbols for transmission of the set of feedback bits. In some examples, the indication of the change in slot format may specify that one or more flexible symbols are to be uplink or downlink symbols. The slot format change indication may be included in an RRC signal (e.g., SlotFormatCombinationsPerCell field). In some examples, the amount of uplink symbols in a slot prior to the slot format change indication may be greater than the amount of uplink symbols in a slot after the slot format change indication.

At 415, the UE 115-c may receive, from the base station 105-c, one or more SPS transmissions. At 420, the UE 115-c may generate a set of feedback bits associated with one or more SPS transmissions. The set of feedback bits may include bits corresponding to an ACK or NACK that indicate whether the UE 115-c was able to successfully decode the one or more SPS transmissions. The set of feedback bits may be scheduled for transmission to the base station 105-c in a first set of uplink symbols.

At 425, the UE 115-c may identify that the availability of the first set of uplink symbols for transmission of the set of feedback bits has changed. The identification that the availability of the feedback bits has changed based at least in part on the indication of the change in the slot format. For example, the UE 115-c may identify that one or more of the first set of uplink symbols now correspond to downlink symbols according to the slot format change indication.

At 430, the base station 105-c may analyze traffic conditions. The analysis may include determining a number of received NACKs in a prior number of semi-persistent scheduling occasions or in a prior number of slots. For example, the base station 105-c may determine that the number the number of NACKs that the UE 115-c has transmitted or that the base station 105-c has received in a number of prior SPS occasions or prior slots. The base station 105-c may compare the number of NACKs to a threshold. Additionally or alternatively, the base station 105-c may determine a probability that the UE 115-c is to transmit a NACK corresponding to one or more scheduled SPS transmissions (e.g., based on channel quality measurements). The base station 105-c may compare the NACK probability to a NACK probability threshold. Additionally or alternatively, the base station 105-c may determine that a second set of uplink symbols are to be used for communication of uplink information other than the set of feedback bits. In some examples, the base station 105-a may compare a prior number of ACKs to an ACK threshold, compare an ACK probability to an ACK threshold, or determine that the uplink symbols are not to be used for information other than feedback.

At 435, the UE 115-c may receive, from the base station 105-c, a second control message that temporarily overrides the first configuration so that the UE uses a second configuration for management of the set of feedback bits in accordance with the availability of the first set of uplink symbols having changed. The second control message may be an example of a DCI message, a MAC-CE message, or an RRC message. The second control message may be transmitted by the base station 105-c based at least in part on the analysis of the traffic conditions at 430. That is, upon satisfaction of NACK threshold, satisfaction of a NACK probability threshold, determination that the uplink symbols are to be used for other information, the base station 105-c may transmit the second control message. The second control message may include an indication of a number of slots or TTIs during which the UE 115-c is to use the second configuration, thus temporarily overriding the first configuration. In some examples, the second control message may be transmitted and/or the traffic conditions may be analyzed before transmission of the slot format change indication or before the SPS transmissions. That is, the base station 105-c may identify that the slot format is to change and determine that the UE 115-c is to use the second configuration in cases where the uplink symbols for feedback are not available for transmission of the feedback (e.g., the uplink symbols are changed to downlink).

At 440, the UE 115-c may transmit at least a portion of the set of feedback bits in a second set of uplink symbols in accordance with the second configuration being that the UE 115-c is to defer transmission of the feedback. The second set of uplink symbols may be example of the first available uplink symbols after the first set of unavailable symbols. In some examples, the second set of uplink symbols are symbols that do not conflict with another uplink transmission.

At 445, the UE 115-c may refrain from transmitting the set of feedback bits in a second set of uplink symbols based at least in part on the second configuration being that the UE is to refrain from deferring transmission of the feedback. In such cases, the UE 115-c may not transmit the feedback bits for the one or more SPS configurations.

Thus, in some examples, the default or first configuration is that the UE 115-c is to defer transmission of the feedback bits (e.g., transmit the feedback bits in uplink symbols subsequent to the symbols that are unavailability). In such cases, the base station 105-c may determine that a NACK is unlikely or an ACK is likely (e.g., based on the traffic condition analysis) or that the uplink symbols in during subsequent slots are to be used for other information. Thus, in such cases, the base station 105-c may determine that the feedback bits are not to be transmitted. Accordingly, the base station may transmit the second control message to indicate that the UE is to temporarily use the second configuration (e.g., not defer—not transmit the feedback). In other examples, the default or first configuration is that the UE is to not defer or not transmit the feedback. In such cases, the base station 105-c may determine that a NACK is likely or ACK is unlikely (e.g., based on the traffic condition analysis and thresholds) or that the uplink symbols in subsequent slots are not to be used for other information. Thus, in such cases, the base station 105-c may determine that the feedback bits are to be transmitted. Accordingly, the base station 105-c may transmit the second control message to indicate that the UE 115-c is to temporarily use the second configuration (e.g., defer—transmit the feedback bits using subsequent uplink symbol(s)).

Using these techniques, the base station 105-c may be able to switch UE behavior on-demand based on traffic conditions or the use or lack of use for uplink symbols for other uplink information. Thus, these techniques may support improved communication reliability and throughput, among other benefits.

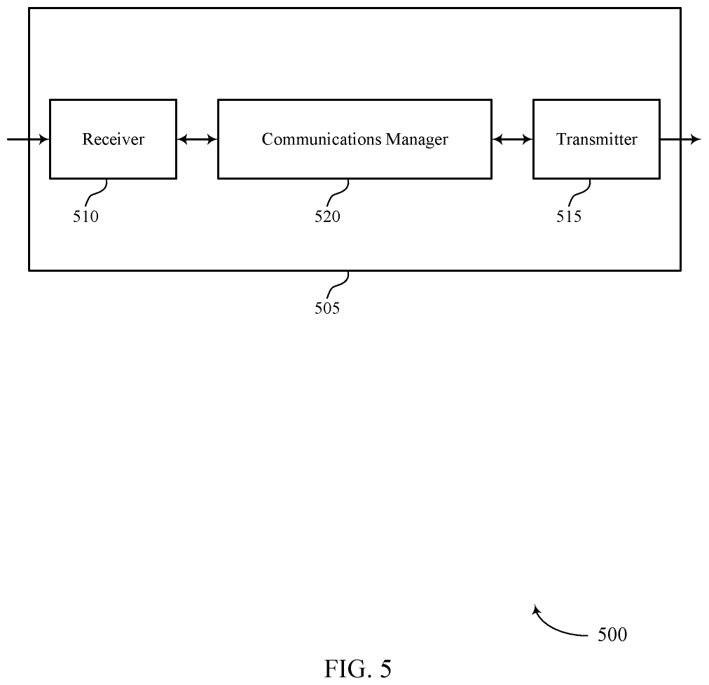

FIG. 5 shows a block diagram 500 of a device 505 that supports on demand transmission of deferred semi-persistent scheduling feedback in accordance with aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to on demand transmission of deferred semi-persistent scheduling feedback). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to on demand transmission of deferred semi-persistent scheduling feedback). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of on demand transmission of deferred semi-persistent scheduling feedback as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communications at a UE in accordance with examples as disclosed herein. For example, the communications manager 520 may be configured as or otherwise support a means for receiving a first control message that indicates a first configuration for management of feedback for semi-persistent scheduling transmissions when availability of one or more uplink symbols in which the feedback is scheduled for transmission to a base station changes. The communications manager 520 may be configured as or otherwise support a means for generating a set of feedback bits associated with one or more semi-persistent scheduling transmissions, the set of feedback bits scheduled for transmission to the base station in a first set of uplink symbols. The communications manager 520 may be configured as or otherwise support a means for identifying that the availability of the first set of uplink symbols for transmission of the set of feedback bits has changed. The communications manager 520 may be configured as or otherwise support a means for receiving a second control message that temporarily overrides the first configuration so that the UE uses a second configuration for management of the set of feedback bits in accordance with the availability of the first set of uplink symbols having changed.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for more efficient utilization of communication resources by deferring transmissions (e.g., feedback transmissions) or not deferring transmissions in some situations, thereby reducing power consumption and processing overhead.

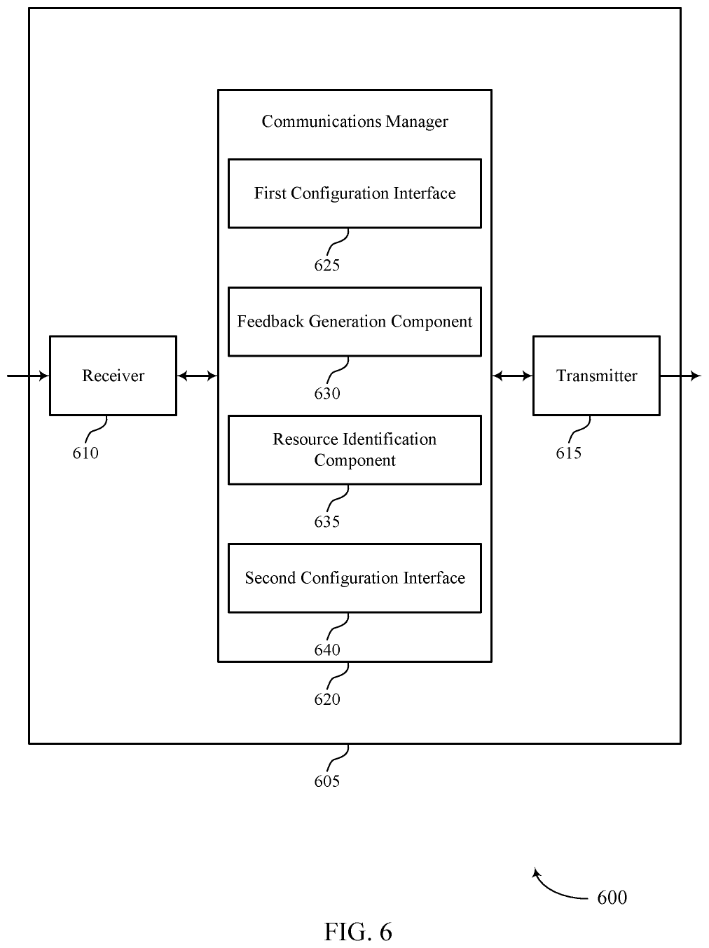

FIG. 6 shows a block diagram 600 of a device 605 that supports on demand transmission of deferred semi-persistent scheduling feedback in accordance with aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to on demand transmission of deferred semi-persistent scheduling feedback). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to on demand transmission of deferred semi-persistent scheduling feedback). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of on demand transmission of deferred semi-persistent scheduling feedback as described herein. For example, the communications manager 620 may include a first configuration interface 625, a feedback generation component 630, a resource identification component 635, a second configuration interface 640, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communications at a UE in accordance with examples as disclosed herein. The first configuration interface 625 may be configured as or otherwise support a means for receiving a first control message that indicates a first configuration for management of feedback for semi-persistent scheduling transmissions when availability of one or more uplink symbols in which the feedback is scheduled for transmission to a base station changes. The feedback generation component 630 may be configured as or otherwise support a means for generating a set of feedback bits associated with one or more semi-persistent scheduling transmissions, the set of feedback bits scheduled for transmission to the base station in a first set of uplink symbols. The resource identification component 635 may be configured as or otherwise support a means for identifying that the availability of the first set of uplink symbols for transmission of the set of feedback bits has changed. The second configuration interface 640 may be configured as or otherwise support a means for receiving a second control message that temporarily overrides the first configuration so that the UE uses a second configuration for management of the set of feedback bits in accordance with the availability of the first set of uplink symbols having changed.

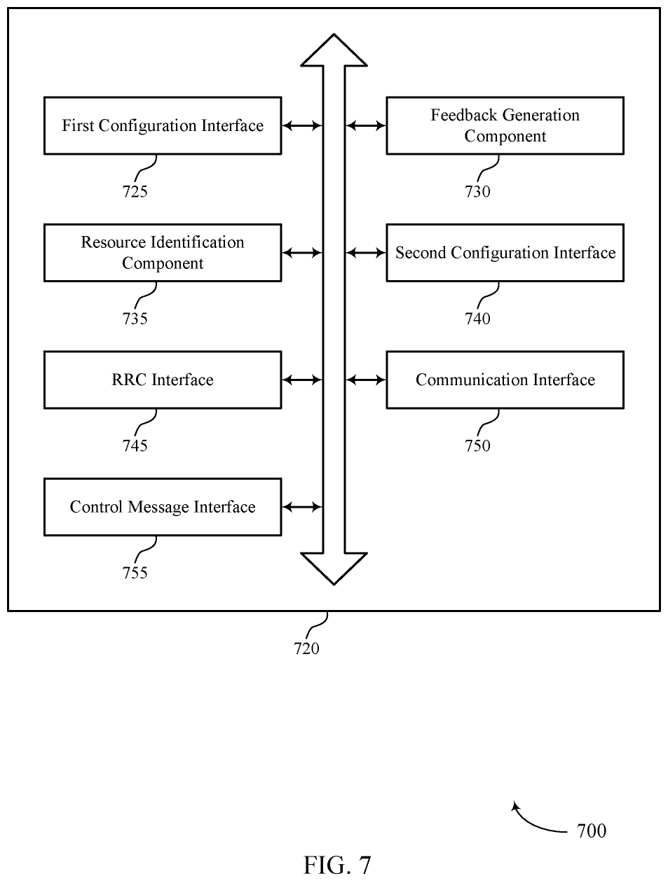

FIG. 7 shows a block diagram 700 of a communications manager 720 that supports on demand transmission of deferred semi-persistent scheduling feedback in accordance with aspects of the present disclosure. The communications manager 720 may be an example of aspects of a communications manager 520, a communications manager 620, or both, as described herein. The communications manager 720, or various components thereof, may be an example of means for performing various aspects of on demand transmission of deferred semi-persistent scheduling feedback as described herein. For example, the communications manager 720 may include a first configuration interface 725, a feedback generation component 730, a resource identification component 735, a second configuration interface 740, an RRC interface 745, a communication interface 750, a control message interface 755, or any combination thereof. Each of these components may communicate, directly or indirectly, with one another (e.g., via one or more buses).

The communications manager 720 may support wireless communications at a UE in accordance with examples as disclosed herein. The first configuration interface 725 may be configured as or otherwise support a means for receiving a first control message that indicates a first configuration for management of feedback for semi-persistent scheduling transmissions when availability of one or more uplink symbols in which the feedback is scheduled for transmission to a base station changes. The feedback generation component 730 may be configured as or otherwise support a means for generating a set of feedback bits associated with one or more semi-persistent scheduling transmissions, the set of feedback bits scheduled for transmission to the base station in a first set of uplink symbols. The resource identification component 735 may be configured as or otherwise support a means for identifying that the availability of the first set of uplink symbols for transmission of the set of feedback bits has changed. The second configuration interface 740 may be configured as or otherwise support a means for receiving a second control message that temporarily overrides the first configuration so that the UE uses a second configuration for management of the set of feedback bits in accordance with the availability of the first set of uplink symbols having changed.

In some examples, to support receiving the first control message, the RRC interface 745 may be configured as or otherwise support a means for receiving a radio resource control message that indicates the first configuration that the UE is to use for management of the feedback.

In some examples, to support communicating with the base station, the communication interface 750 may be configured as or otherwise support a means for transmitting at least a portion of the set of feedback bits in a second set of uplink symbols in accordance with the second configuration being that the UE is to defer transmission of the feedback.

In some examples, the communication interface 750 may be configured as or otherwise support a means for refraining from transmitting the set of feedback bits in a second set of uplink symbols based on the second configuration being that the UE is to refrain from deferring transmission of the feedback.

In some examples, to support receiving the second control message, the control message interface 755 may be configured as or otherwise support a means for receiving a downlink control information message or a medium access control layer control element message that indicates the second configuration.

In some examples, to support receiving the second control message, the RRC interface 745 may be configured as or otherwise support a means for receiving a radio resource control message that indicates the second configuration.

In some examples, to support receiving the second control message, the second configuration interface 740 may be configured as or otherwise support a means for receiving the second control message that specifies a number of transmission time intervals during which the second configuration is to be used for management of the feedback.

In some examples, to support identifying that the availability of the first set of uplink symbols has changed, the control message interface 755 may be configured as or otherwise support a means for receiving a third control message that includes a slot format change indication that changes the availability of the first set of uplink symbols for transmission of the set of feedback bits, where the second configuration is applied for determining whether to transmit the set of feedback bits based on the slot format change indication.

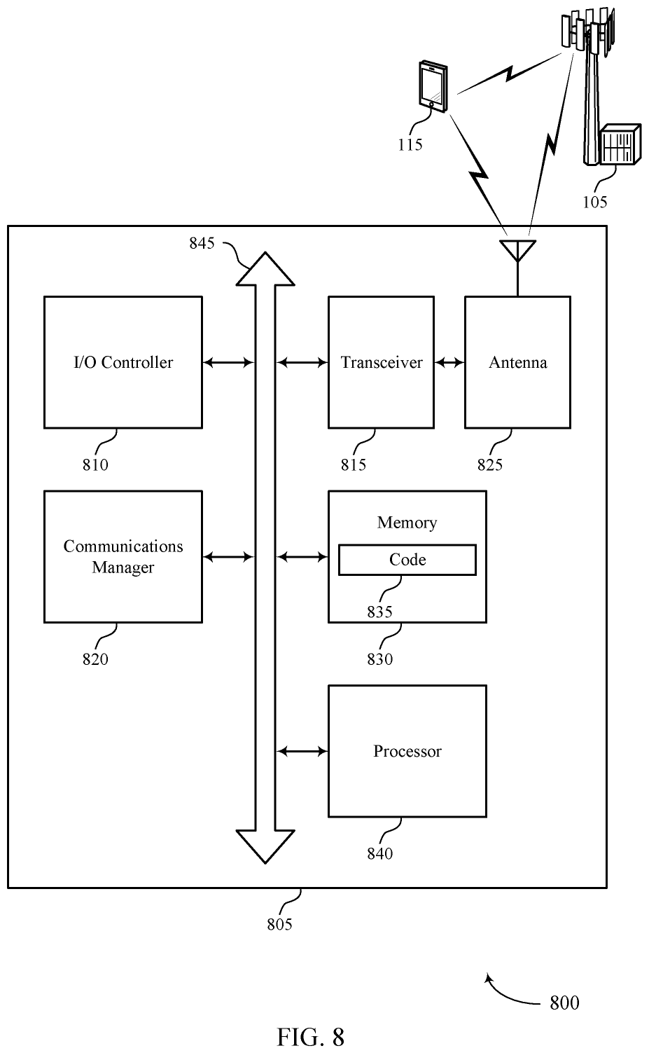

FIG. 8 shows a diagram of a system 800 including a device 805 that supports on demand transmission of deferred semi-persistent scheduling feedback in accordance with aspects of the present disclosure. The device 805 may be an example of or include the components of a device 505, a device 605, or a UE 115 as described herein. The device 805 may communicate wirelessly with one or more base stations 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting on demand transmission of deferred semi-persistent scheduling feedback). For example, the device 805 or a component of the device 805 may include a processor 840 and memory 830 coupled with the processor 840, the processor 840 and memory 830 configured to perform various functions described herein.

The communications manager 820 may support wireless communications at a UE in accordance with examples as disclosed herein. For example, the communications manager 820 may be configured as or otherwise support a means for receiving a first control message that indicates a first configuration for management of feedback for semi-persistent scheduling transmissions when availability of one or more uplink symbols in which the feedback is scheduled for transmission to a base station changes. The communications manager 820 may be configured as or otherwise support a means for generating a set of feedback bits associated with one or more semi-persistent scheduling transmissions, the set of feedback bits scheduled for transmission to the base station in a first set of uplink symbols. The communications manager 820 may be configured as or otherwise support a means for identifying that the availability of the first set of uplink symbols for transmission of the set of feedback bits has changed. The communications manager 820 may be configured as or otherwise support a means for receiving a second control message that temporarily overrides the first configuration so that the UE uses a second configuration for management of the set of feedback bits in accordance with the availability of the first set of uplink symbols having changed.

By including or configuring the communications manager 820 in accordance with examples as described herein, the device 805 may support techniques for more efficient utilization of communication resources by deferring transmissions (e.g., feedback transmissions) or not deferring transmissions in some situations, thereby improving communication reliability and throughput.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of on demand transmission of deferred semi-persistent scheduling feedback as described herein, or the processor 840 and the memory 830 may be otherwise configured to perform or support such operations.

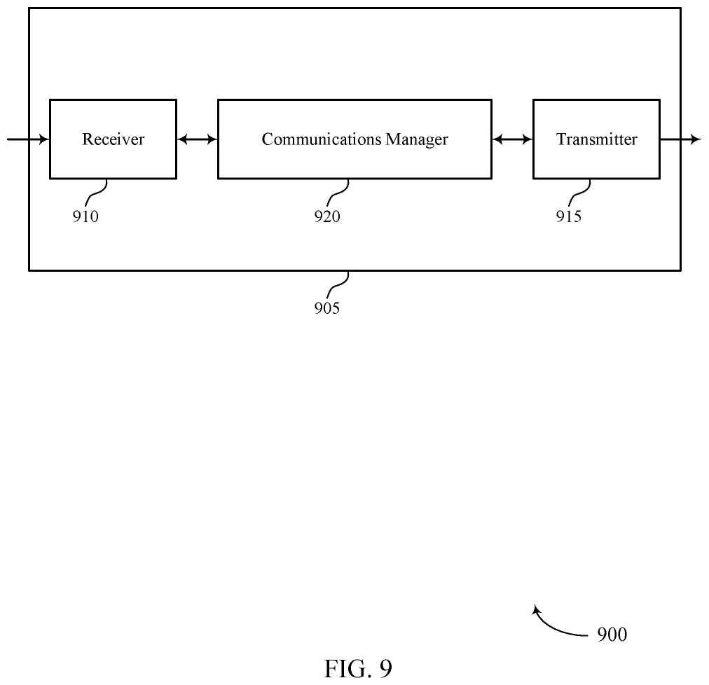

FIG. 9 shows a block diagram 900 of a device 905 that supports on demand transmission of deferred semi-persistent scheduling feedback in accordance with aspects of the present disclosure. The device 905 may be an example of aspects of a base station 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to on demand transmission of deferred semi-persistent scheduling feedback). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to on demand transmission of deferred semi-persistent scheduling feedback). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of on demand transmission of deferred semi-persistent scheduling feedback as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 920, the receiver 910, the transmitter 915, or various combinations or components thereof may be implemented in code (e.g., as communications management software) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 920 may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communications at a base station in accordance with examples as disclosed herein. For example, the communications manager 920 may be configured as or otherwise support a means for transmitting, to a UE, a first control message that indicates a first configuration for management of feedback for semi-persistent scheduling transmissions when availability of one or more uplink symbols in which the feedback is scheduled for transmission to the base station changes. The communications manager 920 may be configured as or otherwise support a means for transmitting, to the UE, one or more semi-persistent scheduling transmissions, where a first set of symbols are to be used by the UE for transmitting a set of feedback bits corresponding to the one or more semi-persistent scheduling transmissions. The communications manager 920 may be configured as or otherwise support a means for identifying that the availability of the first set of uplink symbols for transmission of the set of feedback bits has change. The communications manager 920 may be configured as or otherwise support a means for transmitting, to the UE, a second control message that temporarily overrides the first configuration so that the UE uses a second configuration for management of the set of feedback bits in accordance with the availability of the first set of uplink symbols having changed.

By including or configuring the communications manager 920 in accordance with examples as described herein, the device 905 (e.g., a processor controlling or otherwise coupled with the receiver 910, the transmitter 915, the communications manager 920, or a combination thereof) may support techniques more efficient utilization of communication resources by deferring transmissions (e.g., feedback transmissions) or not deferring transmissions in some situations, thereby reducing power consumption and processing overhead.

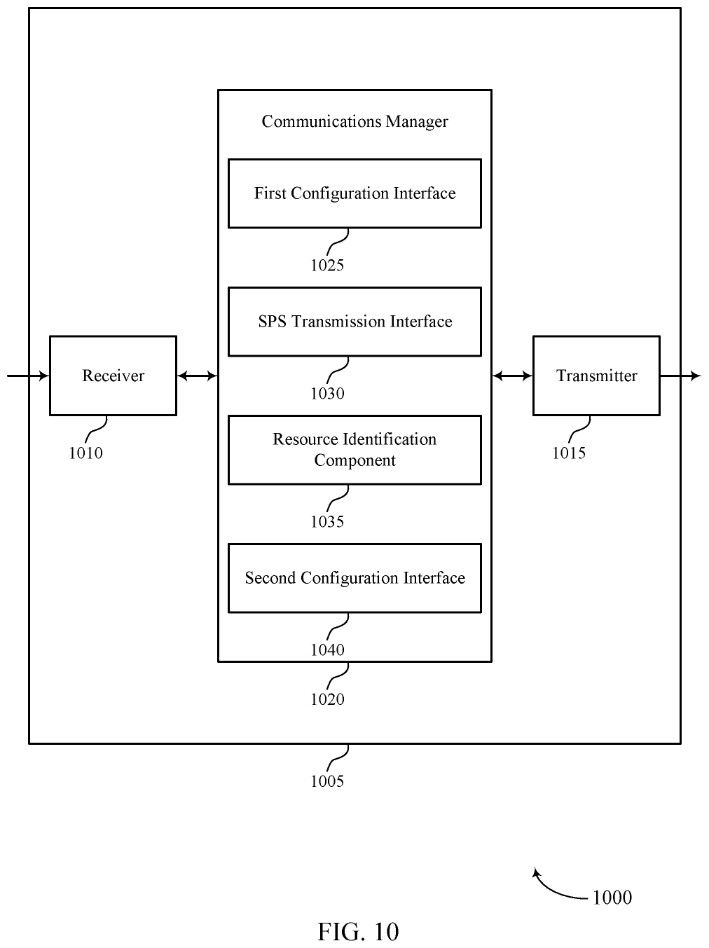

FIG. 10 shows a block diagram 1000 of a device 1005 that supports on demand transmission of deferred semi-persistent scheduling feedback in accordance with aspects of the present disclosure. The device 1005 may be an example of aspects of a device 905 or a base station 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to on demand transmission of deferred semi-persistent scheduling feedback). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to on demand transmission of deferred semi-persistent scheduling feedback). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of on demand transmission of deferred semi-persistent scheduling feedback as described herein. For example, the communications manager 1020 may include a first configuration interface 1025, an SPS transmission interface 1030, a resource identification component 1035, a second configuration interface 1040, or any combination thereof. The communications manager 1020 may be an example of aspects of a communications manager 920 as described herein. In some examples, the communications manager 1020, or various components thereof, may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communications at a base station in accordance with examples as disclosed herein. The first configuration interface 1025 may be configured as or otherwise support a means for transmitting, to a UE, a first control message that indicates a first configuration for management of feedback for semi-persistent scheduling transmissions when availability of one or more uplink symbols in which the feedback is scheduled for transmission to the base station changes. The SPS transmission interface 1030 may be configured as or otherwise support a means for transmitting, to the UE, one or more semi-persistent scheduling transmissions, where a first set of symbols are to be used by the UE for transmitting a set of feedback bits corresponding to the one or more semi-persistent scheduling transmissions. The resource identification component 1035 may be configured as or otherwise support a means for identifying that the availability of the first set of uplink symbols for transmission of the set of feedback bits has change. The second configuration interface 1040 may be configured as or otherwise support a means for transmitting, to the UE, a second control message that temporarily overrides the first configuration so that the UE uses a second configuration for management of the set of feedback bits in accordance with the availability of the first set of uplink symbols having changed.

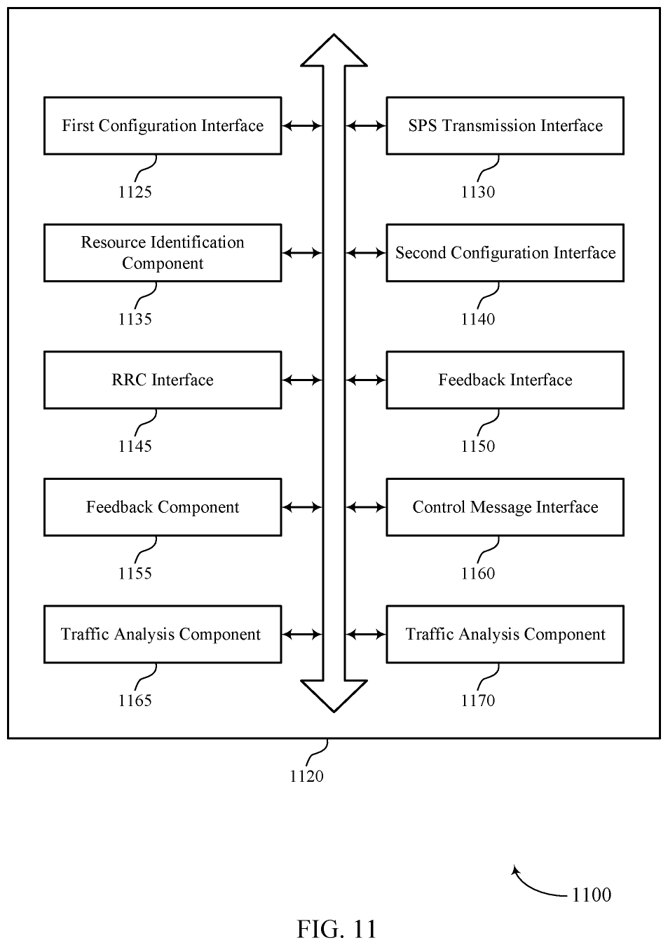

FIG. 11 shows a block diagram 1100 of a communications manager 1120 that supports on demand transmission of deferred semi-persistent scheduling feedback in accordance with aspects of the present disclosure. The communications manager 1120 may be an example of aspects of a communications manager 920, a communications manager 1020, or both, as described herein. The communications manager 1120, or various components thereof, may be an example of means for performing various aspects of on demand transmission of deferred semi-persistent scheduling feedback as described herein. For example, the communications manager 1120 may include a first configuration interface 1125, an SPS transmission interface 1130, a resource identification component 1135, a second configuration interface 1140, an RRC interface 1145, a feedback interface 1150, a feedback component 1155, a control message interface 1160, a traffic analysis component 1165, a traffic analysis component 1170, or any combination thereof. Each of these components may communicate, directly or indirectly, with one another (e.g., via one or more buses).

The communications manager 1120 may support wireless communications at a base station in accordance with examples as disclosed herein. The first configuration interface 1125 may be configured as or otherwise support a means for transmitting, to a UE, a first control message that indicates a first configuration for management of feedback for semi-persistent scheduling transmissions when availability of one or more uplink symbols in which the feedback is scheduled for transmission to the base station changes. The SPS transmission interface 1130 may be configured as or otherwise support a means for transmitting, to the UE, one or more semi-persistent scheduling transmissions, where a first set of symbols are to be used by the UE for transmitting a set of feedback bits corresponding to the one or more semi-persistent scheduling transmissions. The resource identification component 1135 may be configured as or otherwise support a means for identifying that the availability of the first set of uplink symbols for transmission of the set of feedback bits has change. The second configuration interface 1140 may be configured as or otherwise support a means for transmitting, to the UE, a second control message that temporarily overrides the first configuration so that the UE uses a second configuration for management of the set of feedback bits in accordance with the availability of the first set of uplink symbols having changed.

In some examples, to support transmitting the first control message, the RRC interface 1145 may be configured as or otherwise support a means for transmitting a radio resource control message that indicates the first configuration that the UE is to use for management of the feedback.

In some examples, to support communicating with the UE, the feedback interface 1150 may be configured as or otherwise support a means for receiving at least a portion of the set of feedback bits in a second set of uplink symbols in accordance with the second configuration being that the UE is to defer transmission of the feedback.

In some examples, the feedback component 1155 may be configured as or otherwise support a means for determining that the set of feedback bits is not to be received in a second set of uplink symbols based on the second configuration being that the UE is to refrain from deferring transmission of the feedback.

In some examples, to support transmitting the second control message, the control message interface 1160 may be configured as or otherwise support a means for transmitting a downlink control information message or a medium access control layer control element message that indicates the second configuration.

In some examples, to support transmitting the second control message, the RRC interface 1145 may be configured as or otherwise support a means for transmitting a radio resource control message that indicates the second configuration.

In some examples, to support transmitting the second control message, the second configuration interface 1140 may be configured as or otherwise support a means for transmitting the second control message that specifies a number of transmission time intervals during which the second configuration is to be used for management of the feedback.

In some examples, to support identifying that the availability of the first set of uplink symbols has changed, the control message interface 1160 may be configured as or otherwise support a means for transmitting a third control message that includes a slot format change indication that changes the availability of the first set of uplink symbols for transmission of the set of feedback bits, where the second configuration is applied for determining whether to transmit the set of feedback bits based on the slot format change indication.

In some examples, the traffic analysis component 1165 may be configured as or otherwise support a means for determining a number of received negative acknowledgments in a number of semi-persistent scheduling occasions or in a number of slots prior to transmission of the second control message, where the second control message is transmitted based on the number of received negative acknowledgments satisfying a negative acknowledgment threshold.

In some examples, the traffic analysis component 1170 may be configured as or otherwise support a means for determining a probability that the UE is to transmit a negative acknowledgment corresponding to the one or more semi-persistent scheduling transmissions, where the second control message is transmitted based on the determined probability satisfying a negative acknowledgments probability threshold.

In some examples, the traffic analysis component 1170 may be configured as or otherwise support a means for determining that a second set of uplink symbols are to be used for communication of information other than the set of feedback bits, where the second control message is transmitted based on determining that the second set of uplink symbols are to be used for communication of the information other than the set of feedback bits.

In some examples, the traffic analysis component 1170 may be configured as or otherwise support a means for determining a number of received acknowledgments in a number of semi-persistent scheduling occasions or in a number of slots prior to transmission of the second control message, where the second control message is transmitted based on the number of received acknowledgments satisfying an acknowledgment threshold.

In some examples, the traffic analysis component 1170 may be configured as or otherwise support a means for determining a probability that the UE is to transmit an acknowledgment corresponding to the one or more semi-persistent scheduling transmissions, where the second control message is transmitted based on the determined probability satisfying an acknowledgment probability threshold.

In some examples, the traffic analysis component 1170 may be configured as or otherwise support a means for determining that a second set of uplink symbols are to be unused for communication of information other than the set of feedback bits, where the second control message is transmitted based on determining that the second set of uplink symbols are to be unused for communication of the information other than the set of feedback bits.

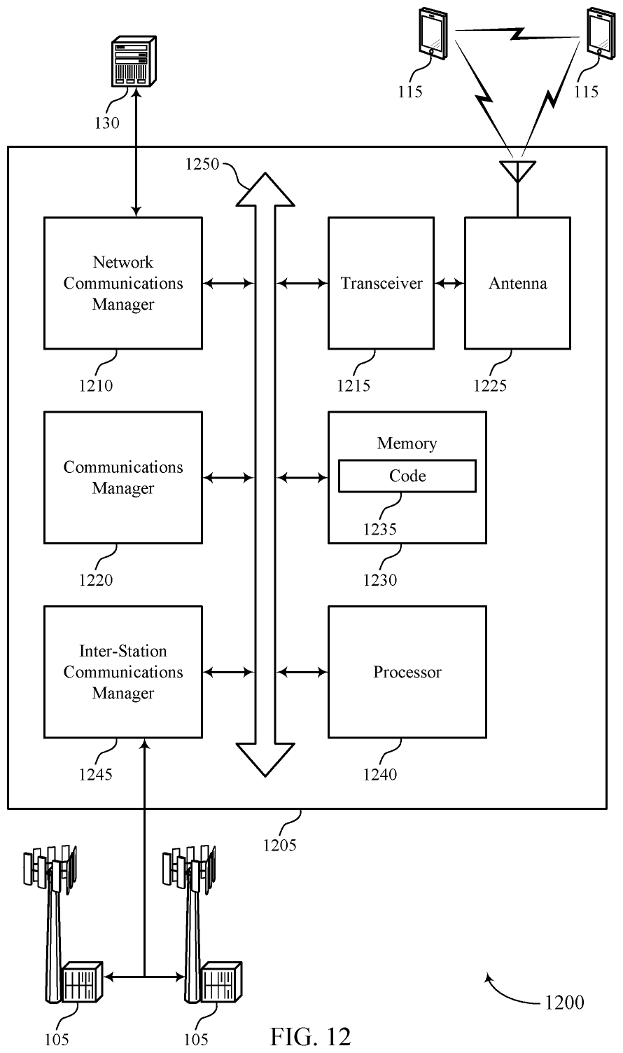

FIG. 12 shows a diagram of a system 1200 including a device 1205 that supports on demand transmission of deferred semi-persistent scheduling feedback in accordance with aspects of the present disclosure. The device 1205 may be an example of or include the components of a device 905, a device 1005, or a base station 105 as described herein. The device 1205 may communicate wirelessly with one or more base stations 105, UEs 115, or any combination thereof. The device 1205 may include components for bi-directional voice and data communications including components for transmitting and receiving communications, such as a communications manager 1220, a network communications manager 1210, a transceiver 1215, an antenna 1225, a memory 1230, code 1235, a processor 1240, and an inter-station communications manager 1245. These components may be in electronic communication or otherwise coupled (e.g., operatively, communicatively, functionally, electronically, electrically) via one or more buses (e.g., a bus 1250).

The network communications manager 1210 may manage communications with a core network 130 (e.g., via one or more wired backhaul links). For example, the network communications manager 1210 may manage the transfer of data communications for client devices, such as one or more UEs 115.

In some cases, the device 1205 may include a single antenna 1225. However, in some other cases the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include RAM and ROM. The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a BIOS which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting on demand transmission of deferred semi-persistent scheduling feedback). For example, the device 1205 or a component of the device 1205 may include a processor 1240 and memory 1230 coupled with the processor 1240, the processor 1240 and memory 1230 configured to perform various functions described herein.

The inter-station communications manager 1245 may manage communications with other base stations 105, and may include a controller or scheduler for controlling communications with UEs 115 in cooperation with other base stations 105. For example, the inter-station communications manager 1245 may coordinate scheduling for transmissions to UEs 115 for various interference mitigation techniques such as beamforming or joint transmission. In some examples, the inter-station communications manager 1245 may provide an X2 interface within an LTE/LTE-A wireless communications network technology to provide communication between base stations 105.

The communications manager 1220 may support wireless communications at a base station in accordance with examples as disclosed herein. For example, the communications manager 1220 may be configured as or otherwise support a means for transmitting, to a UE, a first control message that indicates a first configuration for management of feedback for semi-persistent scheduling transmissions when availability of one or more uplink symbols in which the feedback is scheduled for transmission to the base station changes. The communications manager 1220 may be configured as or otherwise support a means for transmitting, to the UE, one or more semi-persistent scheduling transmissions, where a first set of symbols are to be used by the UE for transmitting a set of feedback bits corresponding to the one or more semi-persistent scheduling transmissions. The communications manager 1220 may be configured as or otherwise support a means for identifying that the availability of the first set of uplink symbols for transmission of the set of feedback bits has change. The communications manager 1220 may be configured as or otherwise support a means for transmitting, to the UE, a second control message that temporarily overrides the first configuration so that the UE uses a second configuration for management of the set of feedback bits in accordance with the availability of the first set of uplink symbols having changed.

By including or configuring the communications manager 1220 in accordance with examples as described herein, the device 1205 may support techniques for more efficient utilization of communication resources by deferring transmissions (e.g., feedback transmissions) or not deferring transmissions in some situations, thereby reducing improving communication reliability and throughput, which may result in increased battery life and user experience.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of on demand transmission of deferred semi-persistent scheduling feedback as described herein, or the processor 1240 and the memory 1230 may be otherwise configured to perform or support such operations.

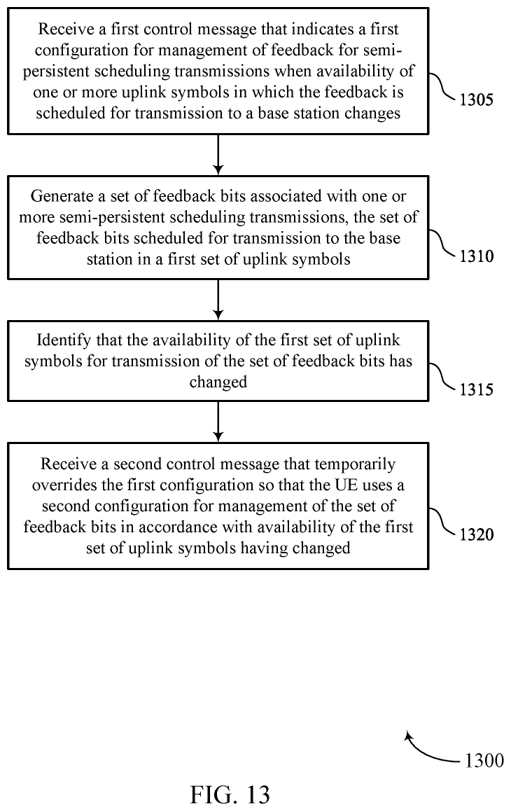

FIG. 13 shows a flowchart illustrating a method 1300 that supports on demand transmission of deferred semi-persistent scheduling feedback in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1305, the method may include receiving a first control message that indicates a first configuration for management of feedback for semi-persistent scheduling transmissions when availability of one or more uplink symbols in which the feedback is scheduled for transmission to a base station or network entity changes. The operations of 1305 may be performed in accordance with examples as disclosed herein. In some examples, aspects of the operations of 1305 may be performed by a first configuration interface 725 as described with reference to FIG. 7.

At 1310, the method may include generating a set of feedback bits associated with one or more semi-persistent scheduling transmissions, the set of feedback bits scheduled for transmission to the base station or network entity in a first set of uplink symbols. The operations of 1310 may be performed in accordance with examples as disclosed herein. In some examples, aspects of the operations of 1310 may be performed by a feedback generation component 730 as described with reference to FIG. 7.

At 1315, the method may include identifying that the availability of the first set of uplink symbols for transmission of the set of feedback bits has changed. The operations of 1315 may be performed in accordance with examples as disclosed herein. In some examples, aspects of the operations of 1315 may be performed by a resource identification component 735 as described with reference to FIG. 7.

At 1320, the method may include receiving a second control message that temporarily overrides the first configuration so that the UE uses a second configuration for management of the set of feedback bits in accordance with the availability of the first set of uplink symbols having changed. The operations of 1320 may be performed in accordance with examples as disclosed herein. In some examples, aspects of the operations of 1320 may be performed by a second configuration interface 740 as described with reference to FIG. 7.

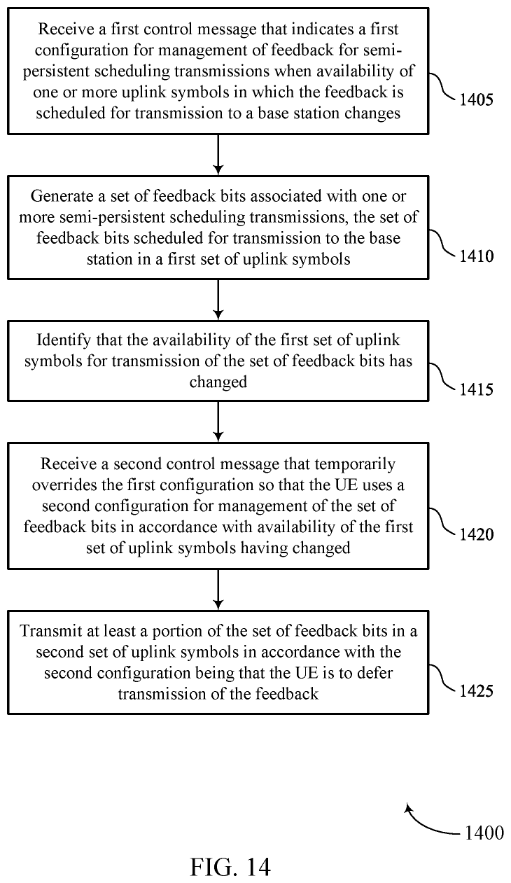

FIG. 14 shows a flowchart illustrating a method 1400 that supports on demand transmission of deferred semi-persistent scheduling feedback in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1405, the method may include receiving a first control message that indicates a first configuration for management of feedback for semi-persistent scheduling transmissions when availability of one or more uplink symbols in which the feedback is scheduled for transmission to a base station or network entity changes. The operations of 1405 may be performed in accordance with examples as disclosed herein. In some examples, aspects of the operations of 1405 may be performed by a first configuration interface 725 as described with reference to FIG. 7.

At 1410, the method may include generating a set of feedback bits associated with one or more semi-persistent scheduling transmissions, the set of feedback bits scheduled for transmission to the base station or network entity in a first set of uplink symbols. The operations of 1410 may be performed in accordance with examples as disclosed herein. In some examples, aspects of the operations of 1410 may be performed by a feedback generation component 730 as described with reference to FIG. 7.

At 1415, the method may include identifying that the availability of the first set of uplink symbols for transmission of the set of feedback bits has changed. The operations of 1415 may be performed in accordance with examples as disclosed herein. In some examples, aspects of the operations of 1415 may be performed by a resource identification component 735 as described with reference to FIG. 7.

At 1420, the method may include receiving a second control message that temporarily overrides the first configuration so that the UE uses a second configuration for management of the set of feedback bits in accordance with the availability of the first set of uplink symbols having changed. The operations of 1420 may be performed in accordance with examples as disclosed herein. In some examples, aspects of the operations of 1420 may be performed by a second configuration interface 740 as described with reference to FIG. 7.

At 1425, the method may include transmitting at least a portion of the set of feedback bits in a second set of uplink symbols in accordance with the second configuration being that the UE is to defer transmission of the feedback. The operations of 1425 may be performed in accordance with examples as disclosed herein. In some examples, aspects of the operations of 1425 may be performed by a communication interface 750 as described with reference to FIG. 7.

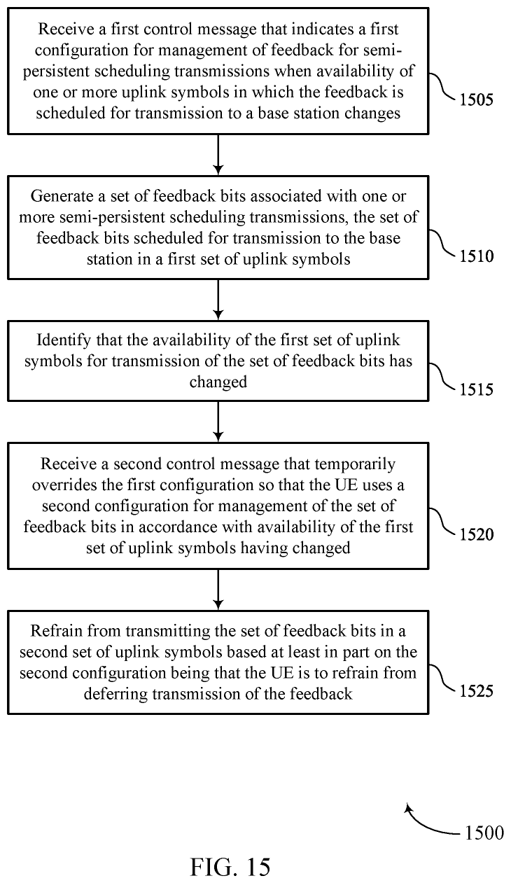

FIG. 15 shows a flowchart illustrating a method 1500 that supports on demand transmission of deferred semi-persistent scheduling feedback in accordance with aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1505, the method may include receiving a first control message that indicates a first configuration for management of feedback for semi-persistent scheduling transmissions when availability of one or more uplink symbols in which the feedback is scheduled for transmission to a base station or network entity changes. The operations of 1505 may be performed in accordance with examples as disclosed herein. In some examples, aspects of the operations of 1505 may be performed by a first configuration interface 725 as described with reference to FIG. 7.

At 1510, the method may include generating a set of feedback bits associated with one or more semi-persistent scheduling transmissions, the set of feedback bits scheduled for transmission to the base station or network entity in a first set of uplink symbols. The operations of 1510 may be performed in accordance with examples as disclosed herein. In some examples, aspects of the operations of 1510 may be performed by a feedback generation component 730 as described with reference to FIG. 7.

At 1515, the method may include identifying that the availability of the first set of uplink symbols for transmission of the set of feedback bits has changed. The operations of 1515 may be performed in accordance with examples as disclosed herein. In some examples, aspects of the operations of 1515 may be performed by a resource identification component 735 as described with reference to FIG. 7.

At 1520, the method may include receiving a second control message that temporarily overrides the first configuration so that the UE uses a second configuration for management of the set of feedback bits in accordance with the availability of the first set of uplink symbols having changed. The operations of 1520 may be performed in accordance with examples as disclosed herein. In some examples, aspects of the operations of 1520 may be performed by a second configuration interface 740 as described with reference to FIG. 7.

At 1525, the method may include refraining from transmitting the set of feedback bits in a second set of uplink symbols based on the second configuration being that the UE is to refrain from deferring transmission of the feedback. The operations of 1525 may be performed in accordance with examples as disclosed herein. In some examples, aspects of the operations of 1525 may be performed by a communication interface 750 as described with reference to FIG. 7.

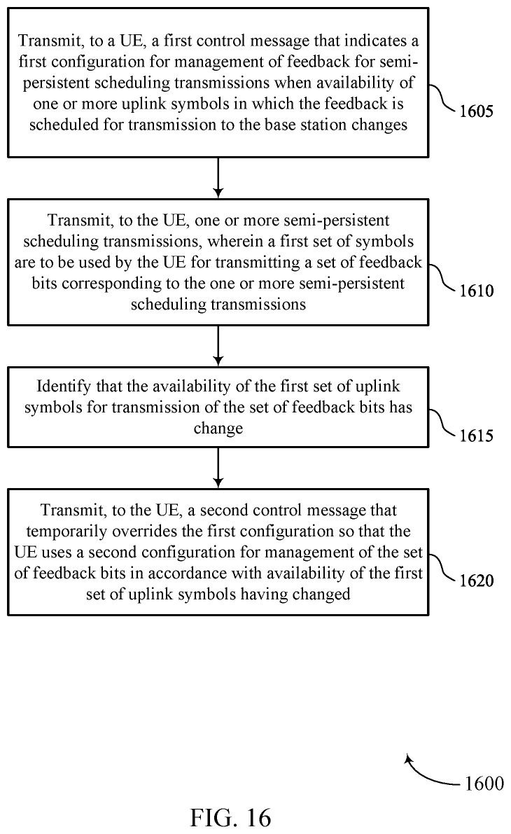

FIG. 16 shows a flowchart illustrating a method 1600 that supports on demand transmission of deferred semi-persistent scheduling feedback in accordance with aspects of the present disclosure. The operations of the method 1600 may be implemented by a base station or network entity or its components as described herein. For example, the operations of the method 1600 may be performed by a base station or network entity 105 as described with reference to FIGS. 1 through 4 and 9 through 12. In some examples, a base station or network entity may execute a set of instructions to control the functional elements of the base station or network entity to perform the described functions. Additionally or alternatively, the base station or network entity may perform aspects of the described functions using special-purpose hardware.

At 1605, the method may include transmitting, to a UE, a first control message that indicates a first configuration for management of feedback for semi-persistent scheduling transmissions when availability of one or more uplink symbols in which the feedback is scheduled for transmission to the base station or network entity changes. The operations of 1605 may be performed in accordance with examples as disclosed herein. In some examples, aspects of the operations of 1605 may be performed by a first configuration interface 1125 as described with reference to FIG. 11.

At 1610, the method may include transmitting, to the UE, one or more semi-persistent scheduling transmissions, where a first set of symbols are to be used by the UE for transmitting a set of feedback bits corresponding to the one or more semi-persistent scheduling transmissions. The operations of 1610 may be performed in accordance with examples as disclosed herein. In some examples, aspects of the operations of 1610 may be performed by an SPS transmission interface 1130 as described with reference to FIG. 11.

At 1615, the method may include identifying that the availability of the first set of uplink symbols for transmission of the set of feedback bits has change. The operations of 1615 may be performed in accordance with examples as disclosed herein. In some examples, aspects of the operations of 1615 may be performed by a resource identification component 1135 as described with reference to FIG. 11.

At 1620, the method may include transmitting, to the UE, a second control message that temporarily overrides the first configuration so that the UE uses a second configuration for management of the set of feedback bits in accordance with the availability of the first set of uplink symbols having changed. The operations of 1620 may be performed in accordance with examples as disclosed herein. In some examples, aspects of the operations of 1620 may be performed by a second configuration interface 1140 as described with reference to FIG. 11.

The following provides an overview of aspects of the present disclosure:

Aspect 1: A method for wireless communications at a UE, comprising: receiving a first control message that indicates a first configuration for management of feedback for semi-persistent scheduling transmissions when availability of one or more uplink symbols in which the feedback is scheduled for transmission to a base station or network entity changes; generating a set of feedback bits associated with one or more semi-persistent scheduling transmissions, the set of feedback bits scheduled for transmission to the base station or network entity in a first set of uplink symbols; identifying that availability of the first set of uplink symbols for transmission of the set of feedback bits has changed; and receiving a second control message that temporarily overrides the first configuration so that the UE uses a second configuration for management of the set of feedback bits in accordance with the availability of the first set of uplink symbols having changed.

Aspect 2: The method of aspect 1, wherein receiving the first control message comprises: receiving a radio resource control message that indicates the first configuration that the UE is to use for management of the feedback.

Aspect 3: The method of any of aspects 1 through 2, further comprising: transmitting at least a portion of the set of feedback bits in a second set of uplink symbols in accordance with the second configuration being that the UE is to defer transmission of the feedback.

Aspect 4: The method of any of aspects 1 through 2 further comprising: refraining from transmitting the set of feedback bits in a second set of uplink symbols based at least in part on the second configuration being that the UE is to refrain from deferring transmission of the feedback.

Aspect 5: The method of any of aspects 1 through 4, wherein receiving the second control message comprises: receiving a downlink control information message or a medium access control layer control element message that indicates the second configuration.

Aspect 6: The method of any of aspects 1 through 4, wherein receiving the second control message comprises: receiving a radio resource control message that indicates the second configuration.

Aspect 7: The method of any of aspects 1 through 6, wherein receiving the second control message comprises: receiving the second control message that specifies a number of transmission time intervals during which the second configuration is to be used for management of the feedback.

Aspect 8: The method of any of aspects 1 through 7, wherein identifying that the availability of the first set of uplink symbols has changed comprises: receiving a third control message that includes a slot format change indication that changes the availability of the first set of uplink symbols for transmission of the set of feedback bits, wherein the second configuration is applied for determining whether to transmit the set of feedback bits based at least in part on the slot format change indication.

Aspect 9: A method for wireless communications at a base station or network entity, comprising: transmitting, to a UE, a first control message that indicates a first configuration for management of feedback for semi-persistent scheduling transmissions when availability of one or more uplink symbols in which the feedback is scheduled for transmission to the base station or network entity changes; transmitting, to the UE, one or more semi-persistent scheduling transmissions, wherein a first set of symbols are to be used by the UE for transmitting a set of feedback bits corresponding to the one or more semi-persistent scheduling transmissions; identifying that availability of the first set of uplink symbols for transmission of the set of feedback bits has change; and transmitting, to the UE, a second control message that temporarily overrides the first configuration so that the UE uses a second configuration for management of the set of feedback bits in accordance with the availability of the first set of uplink symbols having changed.

Aspect 10: The method of aspect 9, wherein transmitting the first control message comprises: transmitting a radio resource control message that indicates the first configuration that the UE is to use for management of the feedback.

Aspect 11: The method of any of aspects 9 through 10, further comprising: receiving at least a portion of the set of feedback bits in a second set of uplink symbols in accordance with the second configuration being that the UE is to defer transmission of the feedback.

Aspect 12: The method of any of aspects 9 through 10, further comprising: determining that the set of feedback bits is not to be received in a second set of uplink symbols based at least in part on the second configuration being that the UE is to refrain from deferring transmission of the feedback.

Aspect 13: The method of any of aspects 9 through 12, wherein transmitting the second control message comprises: transmitting a downlink control information message or a medium access control layer control element message that indicates the second configuration.

Aspect 14: The method of any of aspects 9 through 12, wherein transmitting the second control message comprises: transmitting a radio resource control message that indicates the second configuration.

Aspect 15: The method of any of aspects 9 through 14, wherein transmitting the second control message comprises: transmitting the second control message that specifies a number of transmission time intervals during which the second configuration is to be used for management of the feedback.

Aspect 16: The method of any of aspects 9 through 15, wherein identifying that the availability of the first set of uplink symbols has changed comprises: transmitting a third control message that includes a slot format change indication that changes the availability of the first set of uplink symbols for transmission of the set of feedback bits, wherein the second configuration is applied for determining whether to transmit the set of feedback bits based at least in part on the slot format change indication.

Aspect 17: The method of any of aspects 9 through 16, further comprising: determining a number of received negative acknowledgments in a number of semi-persistent scheduling occasions or in a number of slots prior to transmission of the second control message, wherein the second control message is transmitted based at least in part on the number of received negative acknowledgments satisfying a negative acknowledgment threshold.

Aspect 18: The method of any of aspects 9 through 17, further comprising: determining a probability that the UE is to transmit a negative acknowledgment corresponding to the one or more semi-persistent scheduling transmissions, wherein the second control message is transmitted based at least in part on the determined probability satisfying a negative acknowledgments probability threshold.

Aspect 19: The method of any of aspects 9 through 18, further comprising: determining that a second set of uplink symbols are to be used for communication of information other than the set of feedback bits, wherein the second control message is transmitted based at least in part on determining that the second set of uplink symbols are to be used for communication of the information other than the set of feedback bits.

Aspect 20: The method of any of aspects 9 through 19, further comprising: determining a number of received acknowledgments in a number of semi-persistent scheduling occasions or in a number of slots prior to transmission of the second control message, wherein the second control message is transmitted based at least in part on the number of received acknowledgments satisfying an acknowledgment threshold.

Aspect 21: The method of any of aspects 9 through 20, further comprising: determining a probability that the UE is to transmit an acknowledgment corresponding to the one or more semi-persistent scheduling transmissions, wherein the second control message is transmitted based at least in part on the determined probability satisfying an acknowledgment probability threshold.

Aspect 22: The method of any of aspects 9 through 21, further comprising: determining that a second set of uplink symbols are to be unused for communication of information other than the set of feedback bits, wherein the second control message is transmitted based at least in part on determining that the second set of uplink symbols are to be unused for communication of the information other than the set of feedback bits.

Aspect 23: An apparatus for wireless communications at a UE, comprising a processor; memory coupled with the processor; and instructions stored in the memory and executable by the processor to cause the apparatus or UE to perform a method of any of aspects 1 through 8.

Aspect 24: An apparatus for wireless communications at a UE, comprising at least one means for performing a method of any of aspects 1 through 8.

Aspect 25: A non-transitory computer-readable medium storing code for wireless communications at a UE, the code comprising instructions executable by a processor to perform a method of any of aspects 1 through 8.

Aspect 26: An apparatus for wireless communications at a base station, comprising a processor; memory coupled with the processor; and instructions stored in the memory and executable by the processor to cause the apparatus or base station or network entity to perform a method of any of aspects 9 through 22.

Aspect 27: An apparatus for wireless communications at a base station, comprising at least one means for performing a method of any of aspects 9 through 22.

Aspect 28: A non-transitory computer-readable medium storing code for wireless communications at a base station, the code comprising instructions executable by a processor to perform a method of any of aspects 9 through 22.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination

The term “determine” or “determining” encompasses a wide variety of actions and, therefore, “determining” can include calculating, computing, processing, deriving, investigating, looking up (such as via looking up in a table, a database or another data structure), and ascertaining. Also, “determining” can include receiving (such as receiving information), and accessing (such as accessing data in a memory). Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
receiving a first control message that indicates a first configuration for management of feedback for semi-persistent scheduling transmissions when availability of one or more uplink symbols in which the feedback is scheduled for transmission to a network entity changes;
generating a set of feedback bits associated with one or more semi-persistent scheduling transmissions, the set of feedback bits scheduled for transmission to the network entity in a first set of uplink symbols;
identifying that availability of the first set of uplink symbols for transmission of the set of feedback bits has changed; and
receiving a second control message that temporarily overrides the first configuration so that the UE uses a second configuration for management of the set of feedback bits in accordance with the availability of the first set of uplink symbols having changed.

2. The method of claim 1, wherein receiving the first control message comprises:
receiving a radio resource control message that indicates the first configuration that the UE is to use for management of the feedback.

3. The method of claim 1, further comprising:
transmitting at least a portion of the set of feedback bits in a second set of uplink symbols in accordance with the second configuration being that the UE is to defer transmission of the feedback.

4. The method of claim 1, further comprising:
refraining from transmitting the set of feedback bits in a second set of uplink symbols based at least in part on the second configuration being that the UE is to refrain from deferring transmission of the feedback.

5. The method of claim 1, wherein receiving the second control message comprises:
receiving a downlink control information message or a medium access control layer control element message that indicates the second configuration.

6. The method of claim 1, wherein receiving the second control message comprises:
receiving a radio resource control message that indicates the second configuration.

7. The method of claim 1, wherein receiving the second control message comprises:
receiving the second control message that specifies a number of transmission time intervals during which the second configuration is to be used for management of the feedback.

8. The method of claim 1, wherein identifying that the availability of the first set of uplink symbols has changed comprises:
receiving a third control message that includes a slot format change indication that changes the availability of the first set of uplink symbols for transmission of the set of feedback bits, wherein the second configuration is applied for determining whether to transmit the set of feedback bits based at least in part on the slot format change indication.

9. A method for wireless communications at a network entity, comprising:
transmitting, to a user equipment (UE), a first control message that indicates a first configuration for management of feedback for semi-persistent scheduling transmissions when availability of one or more uplink symbols in which the feedback is scheduled for transmission to the network entity changes;
transmitting, to the UE, one or more semi-persistent scheduling transmissions, wherein a first set of symbols are to be used by the UE for transmitting a set of feedback bits corresponding to the one or more semi-persistent scheduling transmissions;
identifying that availability of the first set of uplink symbols for transmission of the set of feedback bits has change; and
transmitting, to the UE, a second control message that temporarily overrides the first configuration so that the UE uses a second configuration for management of the set of feedback bits in accordance with the availability of the first set of uplink symbols having changed.

10. The method of claim 9, further comprising:
determining a number of received negative acknowledgments in a number of semi-persistent scheduling occasions or in a number of slots prior to transmission of the second control message, wherein the second control message is transmitted based at least in part on the number of received negative acknowledgments satisfying a negative acknowledgment threshold.

11. The method of claim 9, further comprising:
determining a probability that the UE is to transmit a negative acknowledgment corresponding to the one or more semi-persistent scheduling transmissions, wherein the second control message is transmitted based at least in part on the determined probability satisfying a negative acknowledgments probability threshold.

12. The method of claim 9, further comprising:
determining that a second set of uplink symbols are to be used for communication of information other than the set of feedback bits, wherein the second control message is transmitted based at least in part on determining that the second set of uplink symbols are to be used for communication of the information other than the set of feedback bits.

13. The method of claim 9, further comprising:
determining a number of received acknowledgments in a number of semi-persistent scheduling occasions or in a number of slots prior to transmission of the second control message, wherein the second control message is transmitted based at least in part on the number of received acknowledgments satisfying an acknowledgment threshold.

14. The method of claim 9, further comprising:
determining a probability that the UE is to transmit an acknowledgment corresponding to the one or more semi-persistent scheduling transmissions, wherein the second control message is transmitted based at least in part on the determined probability satisfying an acknowledgment probability threshold.

15. The method of claim 9, further comprising:
determining that a second set of uplink symbols are to be unused for communication of information other than the set of feedback bits, wherein the second control message is transmitted based at least in part on determining that the second set of uplink symbols are to be unused for communication of the information other than the set of feedback bits.

16. An apparatus for wireless communications at a user equipment (UE), comprising:
at least one processor;
memory coupled with the at least one processor; and
instructions stored in the memory and executable by the at least one processor to cause the UE to:
receive a first control message that indicates a first configuration for management of feedback for semi-persistent scheduling transmissions when availability of one or more uplink symbols in which the feedback is scheduled for transmission to a network entity changes;
generate a set of feedback bits associated with one or more semi-persistent scheduling transmissions, the set of feedback bits scheduled for transmission to the network entity in a first set of uplink symbols;
identify that availability of the first set of uplink symbols for transmission of the set of feedback bits has changed; and
receive a second control message that temporarily overrides the first configuration so that the UE uses a second configuration for management of the set of feedback bits in accordance with the availability of the first set of uplink symbols having changed.

17. The apparatus of claim 16, wherein the instructions to receive the first control message are executable by the at least one processor to cause the UE to:
receive a radio resource control message that indicates the first configuration that the UE is to use for management of the feedback.

18. The apparatus of claim 16, wherein the instructions are further executable by the at least one processor to cause the UE to:
transmit at least a portion of the set of feedback bits in a second set of uplink symbols in accordance with the second configuration being that the UE is to defer transmission of the feedback.

19. The apparatus of claim 16, wherein the instructions are further executable by the at least one processor to cause the UE to:
refrain from transmitting the set of feedback bits in a second set of uplink symbols based at least in part on the second configuration being that the UE is to refrain from deferring transmission of the feedback.

20. The apparatus of claim 16, wherein the instructions to receive the second control message are executable by the at least one processor to cause the UE to:
receive a downlink control information message or a medium access control layer control element message that indicates the second configuration.

21. The apparatus of claim 16, wherein the instructions to receive the second control message are executable by the at least one processor to cause the UE to:
receive a radio resource control message that indicates the second configuration.

22. The apparatus of claim 16, wherein the instructions to receive the second control message are executable by the at least one processor to cause the UE to:
receive the second control message that specifies a number of transmission time intervals during which the second configuration is to be used for management of the feedback.

23. The apparatus of claim 16, wherein the instructions to identify that the availability of the first set of uplink symbols has changed are executable by the at least one processor to cause the UE to:
receive a third control message that includes a slot format change indication that changes the availability of the first set of uplink symbols for transmission of the set of feedback bits, wherein the second configuration is applied for determining whether to transmit the set of feedback bits based at least in part on the slot format change indication.

24. An apparatus for wireless communications at a network entity, comprising:
at least one processor;
memory coupled with the at least one processor; and
instructions stored in the memory and executable by the at least one processor to cause the network entity to:
transmit, to a user equipment (UE), a first control message that indicates a first configuration for management of feedback for semi-persistent scheduling transmissions when availability of one or more uplink symbols in which the feedback is scheduled for transmission to the network entity changes;
transmit, to the UE, one or more semi-persistent scheduling transmissions, wherein a first set of symbols are to be used by the UE for transmitting a set of feedback bits corresponding to the one or more semi-persistent scheduling transmissions;
identify that availability of the first set of uplink symbols for transmission of the set of feedback bits has change; and
transmit, to the UE, a second control message that temporarily overrides the first configuration so that the UE uses a second configuration for management of the set of feedback bits in accordance with the availability of the first set of uplink symbols having changed.

25. The apparatus of claim 24, wherein the instructions are further executable by the at least one processor to cause the network entity to:
determine a number of received negative acknowledgments in a number of semi-persistent scheduling occasions or in a number of slots prior to transmission of the second control message, wherein the second control message is transmitted based at least in part on the number of received negative acknowledgments satisfying a negative acknowledgment threshold.

26. The apparatus of claim 24, wherein the instructions are further executable by the at least one processor to cause the network entity to:
determine a probability that the UE is to transmit a negative acknowledgment corresponding to the one or more semi-persistent scheduling transmissions, wherein the second control message is transmitted based at least in part on the determined probability satisfying a negative acknowledgments probability threshold.

27. The apparatus of claim 24, wherein the instructions are further executable by the at least one processor to cause the network entity to:
determine that a second set of uplink symbols are to be used for communication of information other than the set of feedback bits, wherein the second control message is transmitted based at least in part on determining that the second set of uplink symbols are to be used for communication of the information other than the set of feedback bits.

28. The apparatus of claim 24, wherein the instructions are further executable by the at least one processor to cause the network entity to:
determine a number of received acknowledgments in a number of semi-persistent scheduling occasions or in a number of slots prior to transmission of the second control message, wherein the second control message is transmitted based at least in part on the number of received acknowledgments satisfying an acknowledgment threshold.

29. The apparatus of claim 24, wherein the instructions are further executable by the at least one processor to cause the network entity to:
determine a probability that the UE is to transmit an acknowledgment corresponding to the one or more semi-persistent scheduling transmissions, wherein the second control message is transmitted based at least in part on the determined probability satisfying an acknowledgment probability threshold.

30. The apparatus of claim 24, wherein the instructions are further executable by the at least one processor to cause the network entity to:
determine that a second set of uplink symbols are to be unused for communication of information other than the set of feedback bits, wherein the second control message is transmitted based at least in part on determining that the second set of uplink symbols are to be unused for communication of the information other than the set of feedback bits.
